(19) United States
(12) Patent Application Publication
(10) Pub. No.: US 2015/0081455 A1
(43) Pub. Date: Mar. 19, 2015

(54) SERVICE PROVIDING APPARATUS AND SERVICE PROVIDING METHOD

(71) Applicant: YAHOO JAPAN CORPORATION, Tokyo (JP)

(72) Inventors: Toru TAKATA, Tokyo (JP); Nobuyuki AKASHI, Tokyo (JP); Akira TAJIMA, Tokyo (JP); Koji TSUKAMOTO, Tokyo (JP); Nari WOO, Tokyo (JP); Akihiro TANABE, Tokyo (JP); Shinichiro SEGA, Tokyo (JP)

(21) Appl. No.: 14/332,874

(22) Filed: Jul. 16, 2014

(30) Foreign Application Priority Data
Sep. 19, 2013 (JP) 2013-194684

(51) Int. Cl. G06Q 30/02

(52) U.S. Cl. CPC G06Q 30/0275
USPC 705/14.71

(57) ABSTRACT

A service providing apparatus includes a calculating unit, a plan receiving unit, and a service providing unit. The calculating unit calculates an evaluation value for a content creator that creates content. The plan receiving unit receives plan information indicating a plan of the content planned by the content creator. The service providing unit presents the evaluation value calculated by the calculating unit and the plan information received by the plan receiving unit, and provides an auction service in which a bid target is a right to display an advertisement on the content.

### CROSS-REFERENCE TO RELATED APPLICATION(S)

The present application claims priority to and incorporates by reference the entire contents of Japanese Patent Application No. 2013-194684 filed in Japan on Sep. 19, 2013.

### BACKGROUND OF THE INVENTION

1. Field of the Invention

The present invention relates to a service providing apparatus and a service providing method.

2. Description of the Related Art

A distribution service has been known which distributes various kinds of content to a terminal apparatus of the user through the Internet. As an example of the distribution service, a moving image distribution service has been known which distributes moving image content and advertising content which is displayed in a display area of the moving image content.

In regard to the moving image distribution service, a technique called a program auction has been proposed. Specifically, in the program auction, sponsors bid for a given amount of investment money and only the sponsor who bids against the other sponsors has a broadcast right to a CM space for broadcasting hours. This program auction is used to make a definite promise to ensure funds beforehand.

However, in the related art, it is not always possible to provide value-added services for advertisers. Specifically, in the known art described above, advertisers simply compete for the broadcast rights for the CM space in the auction. For this reason, it is difficult to provide value-added services to the advertisers attending the auction.

### SUMMARY OF THE INVENTION

It is an object of the present invention to at least partially solve the problems in the conventional technology.

According to one aspect of an embodiment, a service providing apparatus includes a calculating unit configured to calculate an evaluation value for a content creator that creates content; a plan receiving unit configured to receive plan information indicating a plan of the content planned by the content creator; and a providing unit configured to present the evaluation value calculated by the calculating unit and the plan information received by the plan receiving unit, and provide an auction service in which a bid target is a right to display an advertisement on the content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary service providing process according to a first embodiment;

FIG. 2 is a diagram illustrating an exemplary structure of a service providing system according to the first embodiment;

FIG. 3 is a diagram illustrating an exemplary structure a service providing apparatus according to the first embodiment;

FIG. 4 is a diagram illustrating an exemplary auction storage unit according to the first embodiment;

FIG. 5 is a diagram illustrating an exemplary creator storage unit according to the first embodiment;

FIG. 6 is a diagram illustrating an exemplary list page according to the first embodiment;

FIG. 7 is a diagram illustrating an exemplary auction page according to the first embodiment;

FIG. 8 is a sequence diagram illustrating a service providing process by the service providing system according to the first embodiment;

FIG. 9 is a diagram illustrating an exemplary structure of a service providing apparatus according to a second embodiment;

FIG. 10 is a diagram illustrating an exemplary creator storage unit according to the second embodiment;

FIG. 11 is a diagram illustrating an exemplary schedule storage unit according to the second embodiment;

FIG. 12 is a sequence diagram illustrating a service providing process by a service providing system according to the second embodiment;

FIG. 13 is a diagram illustrating an exemplary structure of a service providing apparatus according to a third embodiment;

FIG. 14 is a diagram illustrating an exemplary verification process by a verifying unit according to the third embodiment;

FIG. 15 is a diagram illustrating an exemplary structure of a service providing apparatus according to a fourth embodiment;

FIG. 16 is a diagram illustrating an exemplary auction storage unit according to the fourth embodiment;

FIG. 17 is a diagram illustrating an exemplary structure of a service providing apparatus according to a fifth embodiment;

FIG. 18 is a diagram illustrating an exemplary creator storage unit according to the fifth embodiment;

FIG. 19 is a diagram illustrating exemplary content according to other embodiment; and

FIG. 20 is a hardware structure diagram illustrating an exemplary computer that implements a function of a service providing apparatus.

### DETAILED DESCRIPTION OF THE PREFERRED EMBODIMENTS

Hereinafter, a service providing apparatus, a service providing method, and a service providing program according to exemplary embodiment (hereinafter, referred to as an “embodiment”) will be described in detail with reference to the accompanying drawings. In addition, the service providing apparatus, the service providing method, and the service providing program are not limited by the embodiment. In the following embodiments, the same components are denoted by the same reference numerals and the description thereof will not be repeated.

### First Embodiment

### 1. Service Providing Process

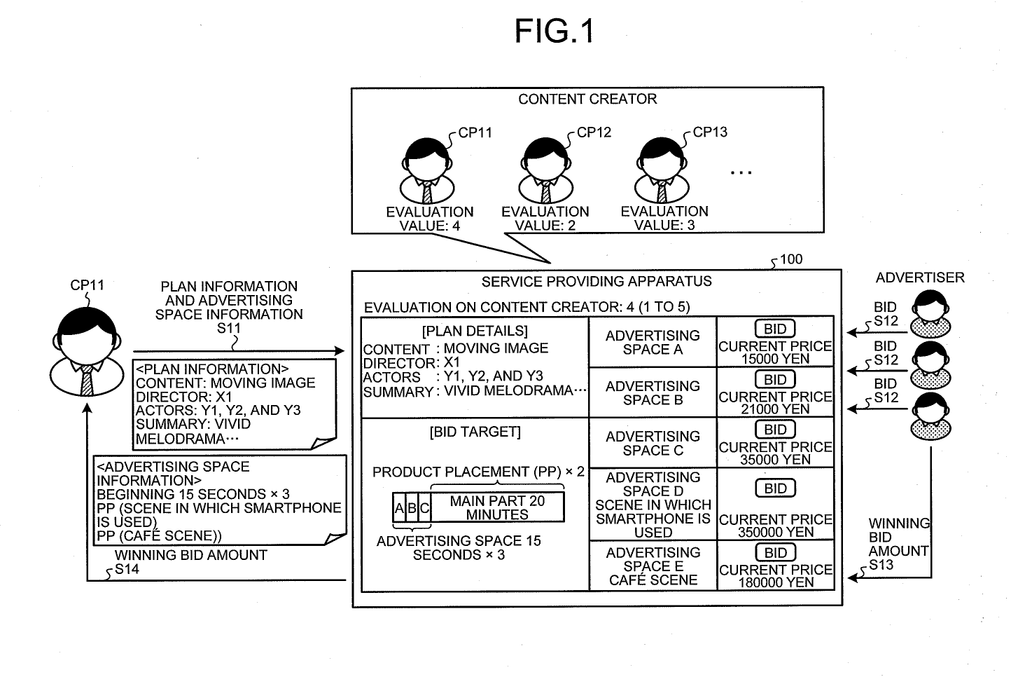

First, an example of the service providing process according to a first embodiment will be described with reference to FIG. 1. FIG. 1 is a diagram illustrating an example of the service providing process according to the first embodiment. A service providing apparatus 100 illustrated in FIG. 1 presents an evaluation value for a content creator who plans to create content, and then provides an auction service in which a bid target, that is an item to be auctioned off, is right to display an advertisement on the content. Hereinafter, a moving image is given as an example of content.

The service providing apparatus 100 illustrated in FIG. 1 calculates an evaluation value for a content creator who creates content. A process of calculating the evaluation value will be described later, but the service providing apparatus 100 calculates an evaluation value for each content creator based on, for example, a previous creation record. The evaluation value indicates an index such as credibility, a creating ability, and a planning ability of a content creator. In the case of the example of FIG. 1, the service providing apparatus 100 calculates an evaluation value “4” for a content creator CP11, calculates an evaluation value “2” for a content creator CP12, and calculates an evaluation value “3” for a content creator CP13. Here, it is assumed that the evaluation value is represented by five steps of “1” to “5”, and evaluation becomes high as a numerical value increases.

Then, as illustrated in FIG. 1, the service providing apparatus 100 receives plan information indicating a plan of moving image and advertising space information relating to an advertising space which is set to the moving image by the content creator CP11 who plans to create the moving image, from the content creator CP11 (step S11). In addition, the service providing apparatus 100 may receive the plan information and the advertising space information at the same time or at different times.

In the example illustrated in FIG. 1, the plan information transmitted by the content creator CP11 includes information indicating that the type of content is a moving image, the director of the moving image is “X1”, the actors of the moving image are “Y1”, “Y2” and “Y3”, and the summary of the moving image is “vivid melodrama”. In addition, the advertising space information transmitted by the content creator CP11 includes information relating to three advertising spaces which are set to the beginning of the moving image, an advertising space which is set to a scene in which a smart phone is used among various kinds of scenes included in the moving image, and an advertising space which is set to a café scene. Here, the advertising space set to the scene in which a smart phone is used or the advertising space set to the scene of the café indicates a cast frame to make a product that an advertiser desires to advertise appear in the moving image. For example, an advertiser who has made a successful bid for the advertising space, which is set for the scene in which a smart phone is used, can make cast members appearing in the moving image use the smart phone to be advertised. Such a method of displaying an advertisement in the main part of the moving image so as to be associated with a specific scene or a cast member is called product placement or the like.

Subsequently, the service providing apparatus 100 presents the evaluation value for the content creator CP11 and the plan information received from the content creator CP11, and provides an auction service in which a right to display an advertisement on an advertising space which is set to a moving image is a bid target. That is, at a stage in which the content creator CP11 plans to create the moving image, the service providing apparatus 100 presents the evaluation value for the content creator CP11, and holds an auction in which the bid target is the right to incorporate an advertisement into the moving image.

In the case of the example of FIG. 1, the service providing apparatus 100 presents “4” to the advertiser as the evaluation value for the content creator CP11. Furthermore, the service providing apparatus 100 makes a type of content, a director, an actor, and a summary public based on the plan information, and individually provides an auction service related to each advertising space based on the advertising space information. Specifically, the service providing apparatus 100 individually holds an auction regarding each of advertising spaces A, B and C to be displayed in the beginning of a moving image and advertising spaces D and E to be displayed in a main part of a moving image.

Subsequently, the service providing apparatus 100 receives bids from the advertiser in each auction (step S12). Then, the service providing apparatus 100 determines the advertiser that bids the highest price to be a winning bidder for the period for which the auction is being held and receives the winning bid amount from the winning bidder (step S13). Then, the service providing apparatus 100 sends the winning bid amount received from the winning bidder to the content creator CP11 (step S14). Although subsequent processes will be described in detail later, the service providing apparatus 100 generates a moving image to be distributed by incorporating advertisement data received from the winning bidder into the moving image created by the content creator CP11 after all auctions for respective advertising spaces are successful. In addition, although the advertisement of a different advertiser is displayed on a general web page for each access to the web page, only advertisement data corresponding to the winning bidder is incorporated into each advertising space set for the content such as a moving image according to the embodiment. That is, an advertiser who has become the winning bidder will monopolize the advertising space in which an advertisement is displayed.

As described above, the service providing apparatus 100 according to the first embodiment presents the evaluation value for the content creator and holds an auction at the stage in which the content creator is planning to create a moving image. As a result, the service providing apparatus 100 enables the advertiser that is a bidder to apprehend, for example, the credibility, the creating ability, or the planning ability of the content creator. Specifically, in the auction service provided by the service providing apparatus 100, a right to display an advertisement on content at the planning stage is a bid target. Thus, the advertiser that is a bidder cannot check a finished product of content at the time of bidding. However, the service providing apparatus 100 according to the first embodiment presents an evaluation value for a content creator, and provides an auction service, and thus even when an auction is held at the stage of planning content, information serving as a reference at the time of bidding can be provided to the advertiser. Accordingly, the service providing apparatus 100 can provide a service having an value-added to the advertiser.

### 2. Structure of Service Providing System

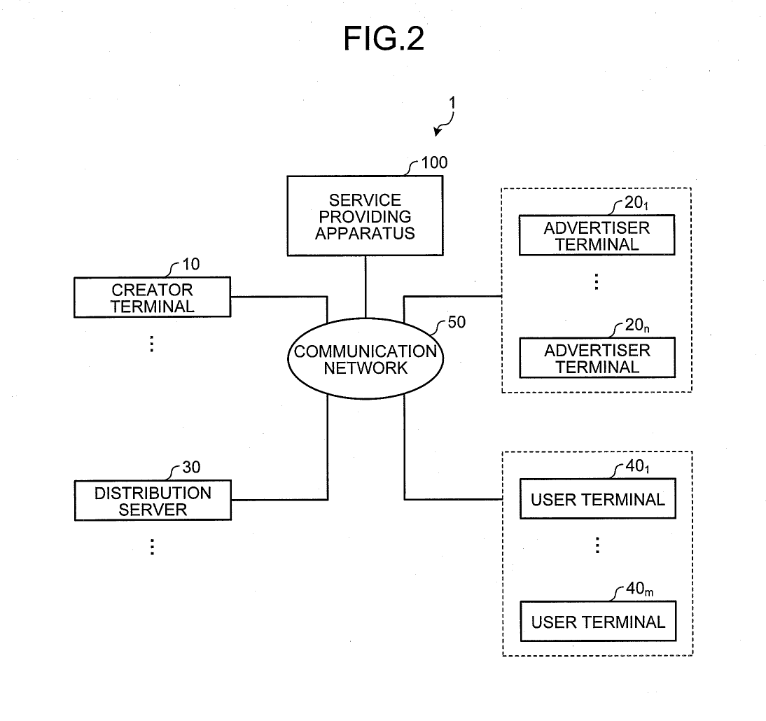

Next, the structure of the service providing system according to the first embodiment will be described with reference to FIG. 2. FIG. 2 is a diagram illustrating an example of the structure of the service providing system according to the first embodiment. As illustrated in FIG. 2, a service providing system 1 includes a creator terminal 10, advertiser terminals 20₁ to 20ₙ, a distribution server 30, user terminals 40₁ to 40ₘ, and the service providing apparatus 100. The creator terminal 10, the advertiser terminals 20₁ to 20ₙ, the distribution server 30, the user terminals 40₁ to 40ₘ, and the service providing apparatus 100 are connected through a communication network 50 so as to communicate with each other wirelessly or by wire. In addition, the service providing system 1 illustrated in FIG. 2 may include a plurality of creator terminals 10, a plurality of distribution servers 30, a plurality of service providing apparatuses 100.

The creator terminal 10 is an information processing apparatus which is used by the content creator. For example, the creator terminal 10 is operated by the content creator to transmit the plan information, the advertising space information, or content, such as a moving image created by the content creator, to the service providing apparatus 100. In the following description, in some cases, the creator terminal 10 is referred to as a content creator. That is, in the following description, the content creator may be replaced with the creator terminal 10.

In some cases, the content creator requests an agent to transmit the plan information. In this case, the agent uses the auction service provided by the service providing apparatus 100. Hereinafter, it is assumed that the term “content creator” includes the agent in addition to the content creator and the term “creator terminal” includes an agent terminal used by the agent in addition to the advertiser terminal.

The advertiser terminals 20₁ to 20ₙ are information processing apparatuses used by advertisers. For example, the advertiser terminals 20₁ to 20ₙ are operated by the advertisers to acquire a web page (hereinafter, may be written as an “auction page”) related to the auction service from the service providing apparatus 100 or to transmit bid information or advertisement data to the service providing apparatus 100. In the following description, in some cases, when it is not necessary to distinguish the advertiser terminals 20₁ to 20ₙ, the advertiser terminals 20₁ to 20ₙ are generically referred to as an “advertiser terminal 20”. In addition, in the following description, in some cases, the advertiser terminal 20 is referred to as an advertiser, a bidder, or a winning bidder. That is, in the following description, the advertiser, the bidder, or the winning bidder may be replaced with the advertiser terminal 20.

In some cases, the advertiser requests the agent to perform a bid operation. In this case, the agent uses the auction service provided by the service providing apparatus 100. In the following description, it is assumed that the term “advertiser” includes the agent in addition to the advertiser and the term “advertiser terminal” includes the agent terminal used by the agent in addition to the advertiser terminal.

The distribution server 30 is, for example, a web server or the like. The distribution server 30 receives distribution target content from the service providing apparatus 100. In addition, the distribution server 30 distributes the content received from the service providing apparatus 100 in response to the requests from the user terminals 40₁ to 40ₘ.

The user terminals 40₁ to 40ₘ are information processing apparatuses used by users who view content. For example, the user terminals 40₁ to 40ₘ are operated by the users to acquire content, such as a moving image, from the distribution server 30 and to display the acquired content on a display device (for example, liquid crystal display). In the following description, when it is not necessary to distinguish the user terminals 40₁ to 40ₘ, the user terminals 40₁ to 40ₘ are generically referred to as a “user terminal 40”. In the following description, in some cases, the user terminal 40 is referred to as a user or a viewer. That is, in the following description, the user or the viewer may be replaced with the user terminal 40.

The service providing apparatus 100 is, for example, a web server or the like. As described with reference to FIG. 1, the service providing apparatus 100 provides the auction service related to the advertising space which is incorporated into content in the planning stage.

The creator terminal 10, the advertiser terminal 20, or the user terminal 40 is implemented by, for example, a desktop personal computer (PC), a notebook PC, a tablet terminal, a mobile phone, or a personal digital assistant (PDA).

### 3. Structure of Service Providing Apparatus

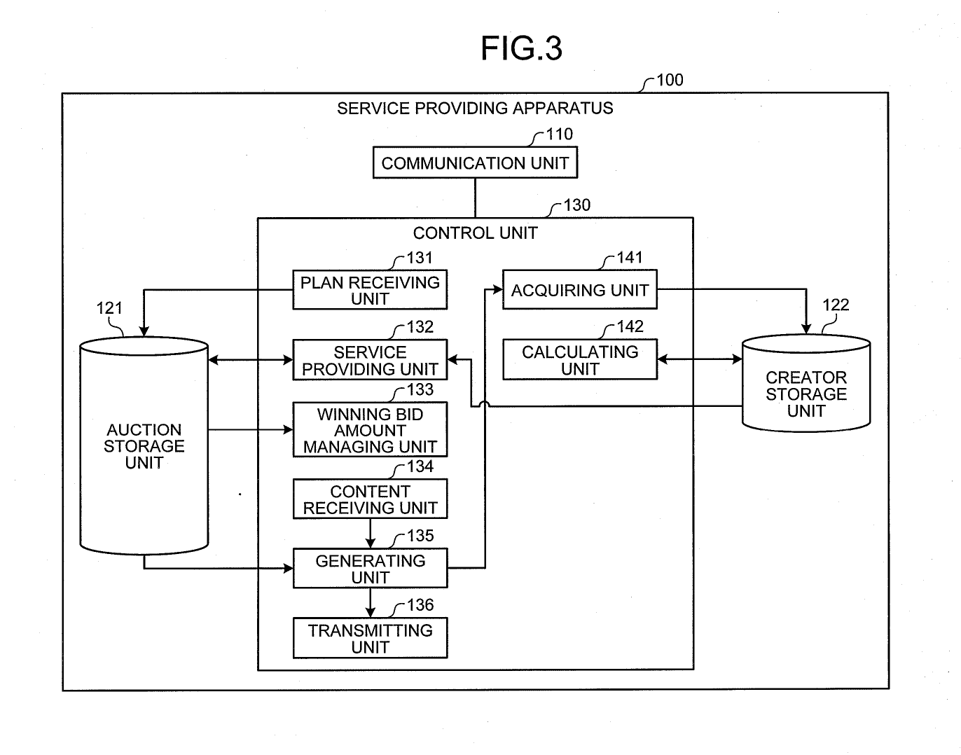

Next, the structure of the service providing apparatus 100 according to the first embodiment will be described with reference to FIG. 3. FIG. 3 is a diagram illustrating an example of the structure of the service providing apparatus 100 according to the first embodiment. As illustrated in FIG. 3, the service providing apparatus 100 includes a communication unit 110, an auction storage unit 121, a creator storage unit 122, and a control unit 130. Note that the service providing apparatus 100 may include an input unit (for example, a keyboard, a mouse, and the like) which receives various types of operations from an administrator of the service providing apparatus 100 or the like or a display unit (for example, a liquid crystal display or the like) which displays various kinds of information.

The communication unit 110 is implemented by, for example, a network interface card (NIC). The communication unit 110 is connected with the communication network 50 in a wired or wireless manner. Then, the communication unit 110 transmits and receives information to and from the creator terminal 10, the advertiser terminal 20, or the distribution server 30 via the communication network 50.

The auction storage unit 121 and the creator storage unit 122 are implemented by a semiconductor memory device such as a random access memory (RAM) and a flash memory or a storage device such as a hard disk and an optical disk.

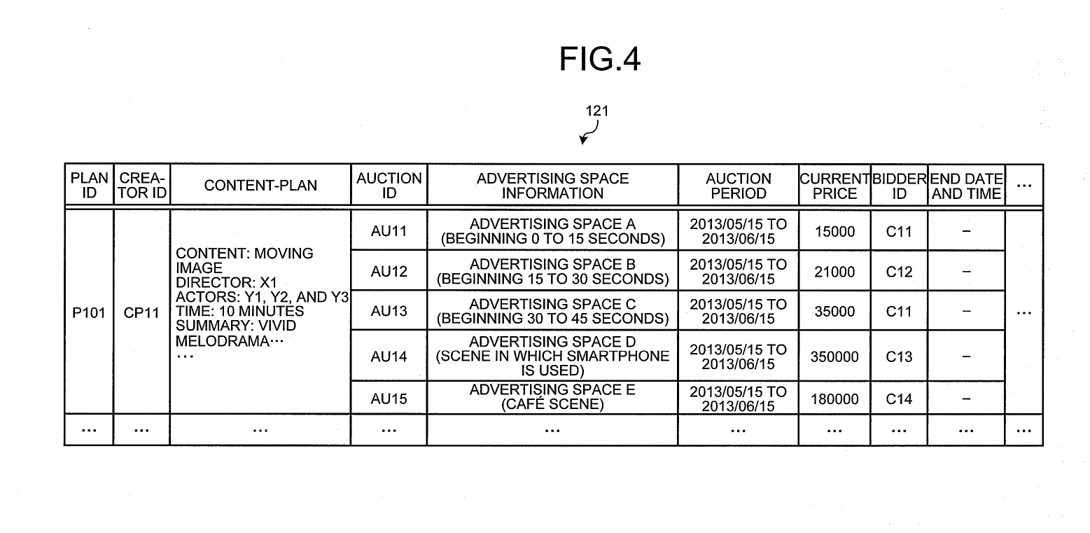

The auction storage unit 121 stores various kinds of information regarding an auction. FIG. 4 illustrates an example of the auction storage unit 121 according to the first embodiment. As illustrated in FIG. 4, the auction storage unit 121 includes items such as a “plan ID”, “creator ID”, “content-plan”, “auction ID”, “advertising space information”, “auction period”, “current price”, “bidder ID”, and “end date and time”.

The “plan ID” indicates identification information for identifying content which is planned to be created by the content creator. The “creator ID” indicates identification information for identifying the content creator. The “content-plan” indicates, for example, skeleton, details or the like of the content. The “auction ID” indicates identification information for identifying the auction related to each advertising space. In other words, the “auction ID” indicates identification information for identifying an advertising space. The “advertising space information” indicates information related to an advertising space incorporated into the content. The “auction period” indicates a period for which the auction is held. The “current price” indicates the highest price of bid prices offered for the auction at the moment. The “bidder ID” indicates an advertiser ID for identifying an advertiser who is a bidder who has bid a highest price at the moment. The “end date and time” indicates date and time when the auction has ended.

Note that in FIG. 4, an auction for which the date and time is not stored in the “end date and time” indicates an auction that is being held or has not been held, and an auction for which the date and time is stored in the “end date and time” indicates an auction that has ended. Furthermore, when the date and time is stored in the “end date and time”, the current price corresponds to the winning bid price, and the bidder corresponds to a winning bidder. Furthermore, in the example of FIG. 4, the “creator ID” is assumed to correspond to a reference numeral given to the content creator illustrated in FIG. 1. For example, a creator ID “CP11” indicates the content creator CP11. Furthermore, hereinafter, information stored in the “bidder ID” illustrated in FIG. 4 is used in some cases as a reference numeral of an advertiser. For example, the advertiser identified by a bidder ID “C11” is described in some cases as an “advertiser C11”.

That is, FIG. 4 illustrates an example in which the content creator CP11 is planning content identified by a plan ID “P101”, and content-plan is a moving image or the like. Furthermore, FIG. 4 illustrates an example in which the five advertising spaces A to E are incorporated into the content. Furthermore, FIG. 4 illustrates an example in which an auction related to the advertising space A is identified by an auction ID “AU11”, and similarly, auctions related to the advertising spaces B to E are identified by auction IDs “AU12”, “AU13”, “AU14”, and “AU15”, respectively. Furthermore, FIG. 4 illustrates an example in which the auctions related to the advertising spaces A to E are being held or are not held yet. As described above, the auction storage unit 121 stores an auction ID corresponding to each advertising space to be incorporated into content in association with one plan ID (that is, content at the planning stage).

Note that information stored in the auction storage unit 121 is not limited to the example illustrated in FIG. 4. For example, the auction storage unit 121 may store a “buyout price” indicating a price at which a successful bid for a bid target can be immediately made, a “lowest winning bid price” indicating a minimum price at which a successful bid for a bid target can be made, or the like for each auction ID. For example, the “buyout price” and the “lowest winning bid price (reserve price)” are included in the advertising space information to be transmitted from the creator terminal 10 to the service providing apparatus 100 and set by the content creator.

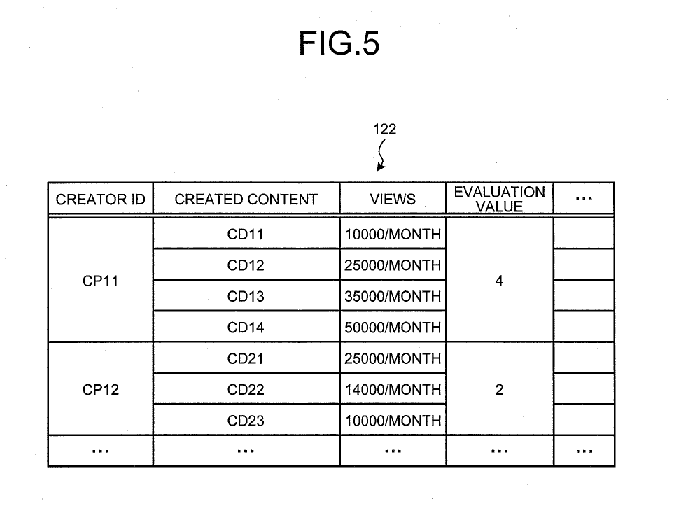

The creator storage unit 122 stores an evaluation value for a content creator and the like. FIG. 5 illustrates an example of the creator storage unit 122 according to the first embodiment. As illustrated in FIG. 5, the creator storage unit 122 includes items such as a “creator ID”, “created content”, “views”, and an “evaluation value”.

The “creator ID” corresponds to the creator ID illustrated in FIG. 4. The “created content” indicates content created in the past by the content creator. FIG. 5 illustrates an example in which conceptual information such as “CD11” is stored in the “created content”, but practically, content such as a moving image, a file path name indicating a storage location of content, or the like is stored.

The “views” indicates the number of times at which content has been viewed or the number of times at which content has been browsed. In other words, the “views” indicates the number of times at which content has been delivered to the user terminal 40 by the distribution server 30. FIG. 5 illustrates an example in which an average value of the views per month is stored in the “views”. The “evaluation value” indicates an index such as the credibility, the creating ability, and the planning ability of the content creator. The “evaluation value” is calculated by a calculating unit 142 which will be described later.

That is, FIG. 5 illustrates an example in which content “CD11”, “CD12”, “CD13”, and “CD14” has been created previously by the content creator CP11. Furthermore, FIG. 5 illustrates an example in which the content “CD11” was viewed 10000 times per month. Furthermore, FIG. 5 illustrates an example in which the evaluation value for the content creator CP11 is “4”, and the evaluation value for the content creator CP12 is “2”.

Referring back to FIG. 3, for example, the control unit 130 is implemented such that a central processing unit (CPU), a micro processing unit (MPU), or the like executes various kinds of programs (corresponding to an exemplary service providing program) stored in an internal storage device of the service providing apparatus 100 using a RAM as a working area. Furthermore, for example, the control unit 130 is implemented by an integrated circuit such as an application specific integrated circuit (ASIC) or a field programmable gate array (FPGA).

As illustrated in FIG. 3, the control unit 130 includes a plan receiving unit 131, a service providing unit 132, a winning bid amount managing unit 133, a content receiving unit 134, a generating unit 135, a transmitting unit 136, an acquiring unit 141, and the calculating unit 142, and implements or executes a function or an operation of information processing which will be described below. Note that an internal structure of the control unit 130 is not limited to the structure illustrated in FIG. 3, and may have other structure as long as it is a structure of performing information processing which will be described later. Furthermore, a connection relation of the respective processing units of the control unit 130 is not limited to the connection relation illustrated in FIG. 3 and may be other connection relation.

The plan receiving unit 131 receives the plan information and the advertising space information from the content creator (for example, the creator terminal 10) who plans to create content. Specifically, the plan receiving unit 131 receives the plan information indicating content-plan and the advertising space information related to an advertising space to be set to content by the content creator from the content creator. Then, when the plan information and the advertising space information is received, the plan receiving unit 131 allocates a new plan ID, and allocates an auction ID for each advertising space to be set to content. Then, the plan receiving unit 131 stores the plan information in the “content-plan” of the auction storage unit 121 in association with the plan ID. Furthermore, the plan receiving unit 131 stores the auction ID for each advertising space in the auction storage unit 121 in association with the plan ID, and further stores the advertising space information in the “advertising space information” of the auction storage unit 121 in association with each auction ID. At this time, the plan receiving unit 131 stores the creator ID corresponding to the content creator that is a transmission source of the plan information and the advertising space information, in the auction storage unit 121 as well. For example, the creator ID is transmitted by the content creator together with the plan information and the advertising space information. Alternatively, when a login process is necessary in using various kinds of services provided by the service providing apparatus 100, a login ID of the content creator or the like may be used as the creator ID.

Note that for example, the plan receiving unit 131 analyzes the plan information, and thus extracts information corresponding to each item such as the type, the director, and an actor of the content. For example, when the plan information is described in a markup language such as an XML (Extensible Markup Language), the plan receiving unit 131 can easily extract information corresponding to each item from the plan information. Furthermore, when the plan information has a predefined format, the plan receiving unit 131 can easily extract various kinds of information from the plan information based on the predefined format. Similarly, when the advertising space information is described in a markup language or when the advertising space information has a predefined format, the plan receiving unit 131 can easily extract various kinds of information from the advertising space information.

Furthermore, the plan receiving unit 131 may receive the advertising space information including the auction period set by the content creator. In this case, the plan receiving unit 131 stores the auction period included in the advertising space information in the auction storage unit 121. However, the plan receiving unit 131 is not limited to this example, and may store a predefined auction period in the auction storage unit 121. For example, the plan receiving unit 131 may use a period of time until a predetermined number of days elapses from a date and time on which the advertising space information was received, as the auction period.

Furthermore, the plan receiving unit 131 may provide a submission site for inputting the plan information and the advertising space information to the content creator. For example, the plan receiving unit 131 provides a submission site for inputting a type of content, content-plan, and the like. Furthermore, for example, the plan receiving unit 131 provides a submission site for inputting a temporal position where an advertising space is reproduced (hereinafter, may be written as a reproduction position), reproduction time of the advertising space, display size of the advertising space, or the like. In this case, the plan receiving unit 131 receives various kinds of information input in the submission site as the plan information and the advertising space information.

The service providing unit 132 presents the evaluation value for the content creator calculated by the calculating unit 142 which will be described later and the plan information received by the plan receiving unit 131, and provides an auction service in which a right to display an advertisement on an advertising space to be set to content by the content creator is a bid target.

Specifically, when a request for an auction page is received from the advertiser terminal 20, the service providing unit 132 provides an auction page to the advertiser terminal 20. At this time, the service providing unit 132 provides an auction page including the evaluation value for a content creator, content-plan of content, and information related to an auction for each advertising space.

For example, the service providing unit 132 acquires various kinds of information related to content being planned from the auction storage unit 121. In the case of the example of FIG. 4, the service providing unit 132 acquires content-plan, advertising space information of each auction ID, a current price, a bidder ID, an end date and time, and the like for each plan ID from the auction storage unit 121. At this time, the service providing unit 132 acquires only various kinds of information corresponding to a plan ID having one or more auctions being held. Specifically, the service providing unit 132 specifies a plan ID corresponding to an auction ID having the present date and time included in the auction period and that has no date information stored in the end date and time, and acquires various kinds of information corresponding to the specified plan ID from the auction storage unit 121. Furthermore, the service providing unit 132 specifies a creator ID corresponding to a plan ID based on the auction storage unit 121, and acquires an evaluation value corresponding to the specified creator ID from the creator storage unit 122.

Then, the service providing unit 132 generates a list page that is a web page on which a list of various kinds of information related to content being planned and an evaluation on a content creator that plans to create the content is displayed. Then, the service providing unit 132 transmits the generated list page to the advertiser terminal 20. As a result, the service providing unit 132 receives an acquisition request including a plan ID corresponding to content being planned selected from the list page from the advertiser terminal 20. In this case, the service providing unit 132 generates an auction page on which content-plan and the like are posted using various kinds of information corresponding to the plan ID included in the acquisition request, and provides the generated auction page to the advertiser terminal 20.

Furthermore, the service providing unit 132 receives bid information including a bidding price from the advertiser terminal 20 through the auction page. In this case, the service providing unit 132 stores the bidding price included in the bid information in the auction storage unit 121 in association with an auction ID indicating a bid target auction. At this time, the service providing unit 132 also stores a bidder ID corresponding to a bidder that is a transmission source of the bid information in the auction storage unit 121. Note that the service providing unit 132 may receive the bidder ID together with the bid information, or may use a login ID of the bidder or the like as the bidder ID. Furthermore, when an auction has been successfully performed, the service providing unit 132 stores a date and time on which the auction ended in the end date and time of the auction storage unit 121.

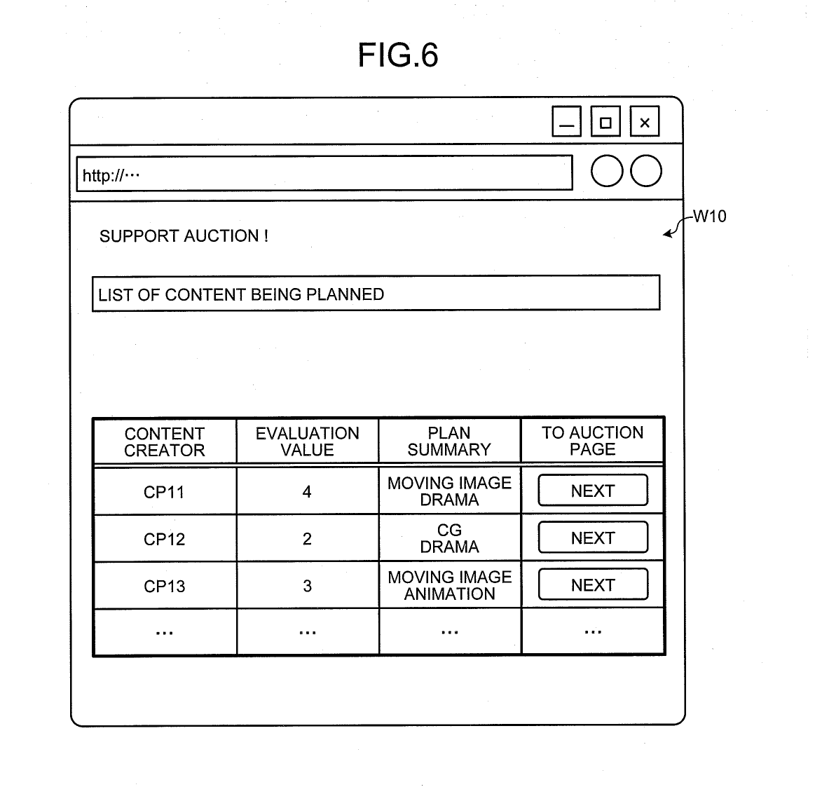

Here, FIG. 6 illustrates an exemplary list page according to the first embodiment. As illustrated in FIG. 6, the service providing unit 132 posts a list of a content creator that is planning to create content, an evaluation value for a content creator, and a plan overview on a list page W10. Furthermore, the service providing unit 132 posts a “next” button for selecting content being planned on the list page W10. Note that the plan overview corresponds to a part or all of content-plan stored in the auction storage unit 121.

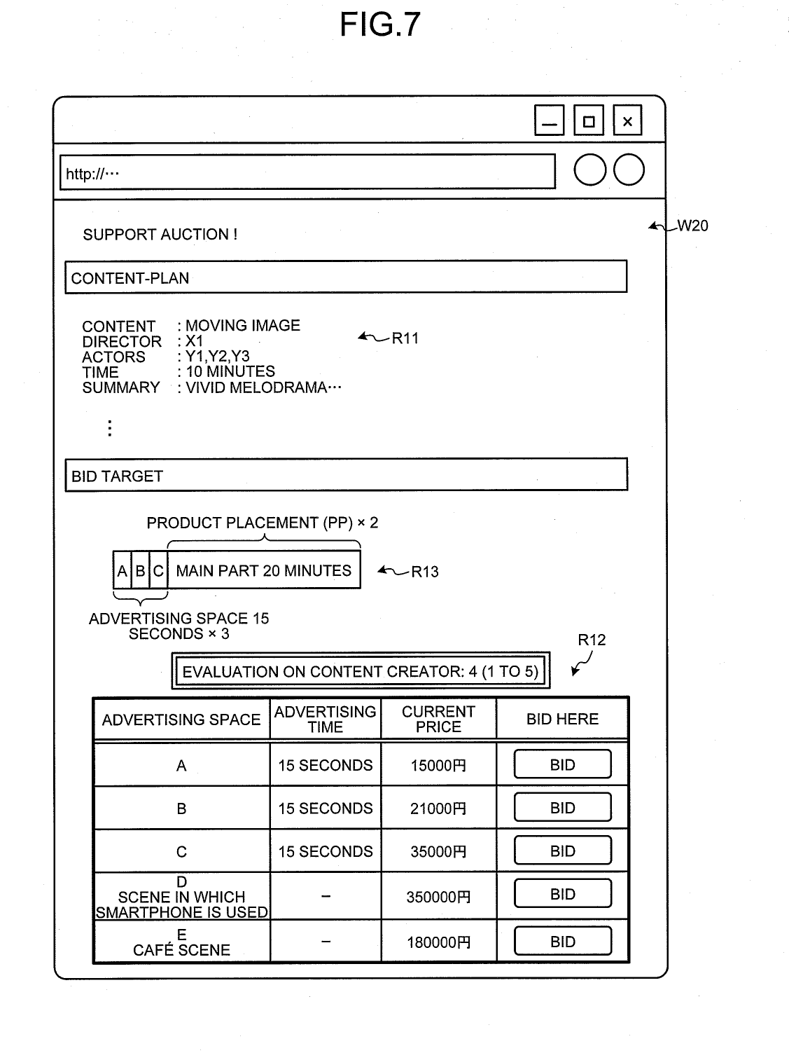

Then, when any of content being planned is selected in the list page W10 illustrated in FIG. 6, the service providing unit 132 delivers an auction page W20 illustrated in FIG. 7 to the advertiser terminal 20. FIG. 7 is a diagram illustrating an example of the auction page W20 according to the first embodiment. FIG. 7 illustrates an example of the auction page W20 corresponding to the plan ID “P101” illustrated in FIG. 4. As illustrated in FIG. 7, the service providing unit 132 posts content-plan stored in the auction storage unit 121 on a plan display field R11 of the auction page W20. Furthermore, the service providing unit 132 posts the evaluation value stored in the creator storage unit 122 in association with the creator ID “CP11” and the advertising space information for each auction ID and the like stored in the auction storage unit 121 in association with the plan ID “P101” on a bidding display field R12 of the auction page W20. Furthermore, the service providing unit 132 posts an image diagram in which a reproduction position of an advertising space is visible on an image display field R13 of the auction page W20. As described above, when information related to a plurality of advertising spaces is included in the advertising space information, the service providing unit 132 posts all the advertising space information on the auction page W20, and individually holds an auction related to each advertising space.

Furthermore, here, although not illustrated, when a bidding button displayed on the bidding display field R12 is pressed down, the service providing unit 132 provides a bidding page for inputting a bidding price to the advertiser terminal 20. As a result, the service providing unit 132 receives the bid information including the bidding price from the advertiser terminal 20 through the bidding page.

Then, when all auctions related to the advertising spaces end, the service providing unit 132 assumes that all auctions have been officially completed. Specifically, even when some auctions among auctions related to the advertising spaces have ended, the service providing unit 132 assumes that such some auctions are provisionally completed, until all auctions are completed. In the case of the example illustrated in FIG. 7, the service providing unit 132 holds five auctions related to the advertising spaces A to E. Here, when a period of time of holding each auction is different or when a buyout price is set to each auction, the five auctions do not necessarily end at the same time. For example, among the five auctions, only an auction related to the advertising space A is assumed to have ended. In this case, the service providing unit 132 assumes that the auction related to the advertising space A is provisionally completed and a winning bidder is provisionally decided, until all the five auctions are completed. Then, after all the five auctions have ended, the service providing unit 132 assumes that all auctions have been officially completed, and finally settles a winning bidder of each auction. That is, the service providing unit 132 stores the end date and time in the auction storage unit 121 each time a winning bidder is decided and an auction ends, but when the end dates and times corresponding to all auction IDs among a plurality of auction IDs associated with one plan ID are stored, all auctions are assumed to have been officially completed.

Here, when some auctions among a plurality of auctions are not completed, the service providing unit 132 may assumes that all auctions are not completed. Examples of the aspect where an auction is not completed include a case in which the number of bids is none and a case in which the highest amount of a bidding price does not reach a lowest winning bid price. In this case, the service providing unit 132 may hold all auctions again. Alternatively, the service providing unit 132 may hold again only some auctions that have not been completed. At this time, the service providing unit 132 may set a lowest winning bid price lower than the last lowest winning bid price in an auction to be held again. Alternatively, when some auctions among a plurality of auctions have not been completed, the service providing unit 132 may notify the content creator of the fact. Then, the service providing unit 132 may hold all auctions again or may decide whether only some auctions that have not been completed are held again, according to an instruction from the content creator.

Note that the list page W10 illustrated in FIG. 6 is not limited to the illustrated example. For example, the service providing unit 132 may post a name of a content creator and the like. Furthermore, the auction page W20 illustrated in the drawing is not limited to the illustrated example. For example, the service providing unit 132 may post a name of a content creator and the like on the plan display field R11. Furthermore, for example, the service providing unit 132 may display information (for example, a company's name or a type of business) related to a bidder that is bidding the highest price. Furthermore, for example, the content creator may set a target amount of a winning bid price in the plan information as an assumed amount of a cost for creating content. In this case, the service providing unit 132 may post the target amount of the winning bid price on the plan display field R11. Furthermore, for example, the service providing unit 132 may post a period of time of holding an auction on the bidding display field R12. Furthermore, for example, the service providing unit 132 may not post an image diagram on the image display field R13.

The winning bid amount managing unit 133 manages the winning bid amount received from the winning bidder who has successfully bid the right. Specifically, even when the winning bid amount is received from the winning bidder, the winning bid amount managing unit 133 instantly stores the entire winning bid amount, without sending the winning bid amount to the content creator. Whenever the content creator charges for the creation of content, the winning bid amount managing unit 133 sends the amount of money corresponding to the charge from the stored reserve price to the content creator. For example, the winning bid amount managing unit 133 receives, from the creator terminal 10, charge data, such as clothing expenses, filming expenses, or food expenses which have been actually used to create content, or food expenses which will be used to create content immediately. Then, the winning bid amount managing unit 133 sends the amount of money corresponding to the received charge data to the content creator. In addition, the winning bid amount managing unit 133 manages winning bid amount using the current price (that is, the highest bid price) stored in the auction storage unit 121.

Thus, the winning bid amount managing unit 133 does not instantly send the winning bid amount received from the winning bidder to the content creator, but gradually sends the winning bid amount in response to the request from the content creator. Therefore, the winning bid amount managing unit 133 can prevent the winning bid amount from being sent to the content creator who does not create content. As a result, the winning bid amount managing unit 133 can prevent the abuse of the auction service provided by the service providing apparatus 100.

In addition, when the total amount of money charged by the content creator is less than the winning bid amount, the winning bid amount managed by the winning bid amount managing unit 133 is left over. In this case, the winning bid amount managing unit 133 may send the surplus money to the content creator after the content creator has created the content. Accordingly, since the winning bid amount managing unit 133 pays the content creator compensation for the completion of the content, it is possible to improve the creative impulse of the content creator.

In addition, although the example where the winning bid amount managing unit 133 transfers winning bid amount to the content creator is illustrated in the example described above, the winning bid amount managing unit 133 may perform only processing for calculating the amount of money transferred to the content creator. Then, the administrator or the like of the service providing apparatus 100 may transfer to the content creator the amount of money calculated by the winning bid amount managing unit 133.

The content receiving unit 134 receives the content corresponding to the plan information from the content creator (for example, the creator terminal 10). For example, when the content creator which has transmitted the plan information completes content, the content receiving unit 134 receives a completed content. In addition, the content receiving unit 134 receives advertisement data which is incorporated into the advertising space from the winning bidder (for example, the advertiser terminal 20).

Note that the winning bidder having the right of displaying an advertisement may transfer this right to another advertiser. In this case, the content receiving unit 134 receives advertisement data not only from the winning bidder but also from an advertiser who has the right of displaying an advertisement. Hereinafter, it is assumed that even when simply expressed as “the winning bidder”, the winning bidder can also include the advertiser to whom the right of displaying an advertisement has been transferred.

The generating unit 135 combines the content and the advertisement data received from the content receiving unit 134 to generate composite content. Specifically, the generating unit 135 generates composite content after all auctions corresponding to the predetermined plan information (plan ID) are successful in the auction service provided by the service providing unit 132. In this case, the generating unit 135 generates composite content by incorporating the advertisement data of the advertiser, who has made a successful bid for the right to display an advertisement in an advertising space set to the content created by the content creator, in the advertising space based on the advertising space information stored in the auction storage unit 121.

In addition, as described above, the advertising space for which the advertiser has made a successful bid may correspond to a cast frame in which an advertising product appears in an image, as in the product placement. In this case, for example, the content creator receives an advertising product from the advertiser, who is a winning bidder, and creates the content, such as a moving image, using the received advertising product. Therefore, when the advertising space is the product placement, the content creator creates composite content including the advertisement data. That is, the content received by the content receiving unit 134 may correspond to composite content. For this reason, the generating unit 135 does not perform the process of generating the composite content when the advertising space set to the content is only the product placement. In other words, the generating unit 135 performs the above process of generating the composite content when advertising spaces that can be incorporated into the finished product of the content, such as the advertising spaces A to C illustrated in FIG. 1 and the like, are set to the content.

The transmitting unit 136 transmits the composite content generated by the generating unit 135 or the composite content received by the content receiving unit 134 to the distribution server 30. As a result, the distribution server 30 distributes the composite content, in which the advertisement data is incorporated, to the user terminal 40 in response to a request from the user terminal 40.

The acquiring unit 141 acquires above-described various kinds of information used in calculating the evaluation value for the content creator. Specifically, the acquiring unit 141 stores the composite content generated by the generating unit 135 in the created content of the creator storage unit 122 in association with the creator ID of the content creator. That is, the acquiring unit 141 stores the composite content generated by the generating unit 135 in the creator storage unit 122 as content having created previously by the content creator. However, the acquiring unit 141 is not limited to this example, and may store content received by the content receiving unit 134 in the created content of the creator storage unit 122.

Furthermore, the acquiring unit 141 accesses periodically the distribution server 30, and acquires the number of deliveries for each piece of composite content from the distribution server 30. Then, the acquiring unit 141 stores the number of deliveries of each piece of composite content in the views of the creator storage unit 122 in association with the composite content (created content). At this time, the acquiring unit 141 accumulates the number of deliveries for each piece of composite content acquired from the distribution server 30, calculates an average value of the views per predetermined period of time (for example, one month), and stores the calculated average value of the views in the views of the creator storage unit 122.

The calculating unit 142 calculates the evaluation value for the content creator. Specifically, the calculating unit 142 according to the first embodiment calculates the evaluation value for the content creator based on the created content and the views stored in the creator storage unit 122. Then, the calculating unit 142 stores the calculated evaluation value in the creator storage unit 122. Here, the calculation process by the calculating unit 142 will be described using a few examples.

For example, the calculating unit 142 calculates a high evaluation value as the number of pieces of created content stored in the creator storage unit 122 increases. In the case of the example of FIG. 5, the content creator CP11 has created four pieces of content previously, and the content creator CP12 has created three pieces of content. In this case, the calculating unit 142 calculates a higher evaluation value for the content creator CP11 than the evaluation value for the content creator CP12. This is because it can be said that a content creator that has created more content previously has more content creation experience or a high content creating ability.

Furthermore, for example, the calculating unit 142 calculates a high evaluation value as a total of the views stored in the creator storage unit 122 increases. In the case of the example of FIG. 5, a total of the views of content having created previously by the content creator CP11 is 120000 times, and a total of the views of content having created previously by the content creator CP12 is 49000 times. In this case, the calculating unit 142 calculates a higher evaluation value for the content creator CP11 than the evaluation value for the content creator CP12. This is because it can be said that the content creator CP11 has created excellent content viewed by more users and has a higher planning ability than the content creator CP12.

Furthermore, for example, the calculating unit 142 may calculate the evaluation value based on whether or not the views has an increasing tendency. Specifically, the calculating unit 142 calculates a high evaluation value when the views is as large as that of newly created composite content. For example, in the example of FIG. 5, the content creator CP11 is assumed to have created composite content “CD11”, “CD12”, “CD13”, and “CD14” in this order, and the content creator CP12 is assumed to have created composite content “CD21”, “CD22”, and “CD23” in this order. In this case, the composite content more recently created by the content creator CP11 has a larger views. On the other hand, the composite content more recently created by the content creator CP12 has a smaller views. In this case, the calculating unit 142 calculates a higher evaluation value for the content creator CP11 having an increasing tendency of the views than the evaluation value for the content creator CP12 having a decreasing tendency of the views. This is because the content creator CP11 has an improved creating ability and likelihood that content which will be created in the future will be viewed by many users.

Note that the calculating unit 142 may calculate the evaluation value for the content creator using two or more evaluation elements among evaluation elements such as the “number of pieces of created content”, the “views”, and the “increasing tendency of the views”.

### 4. Service Providing Process

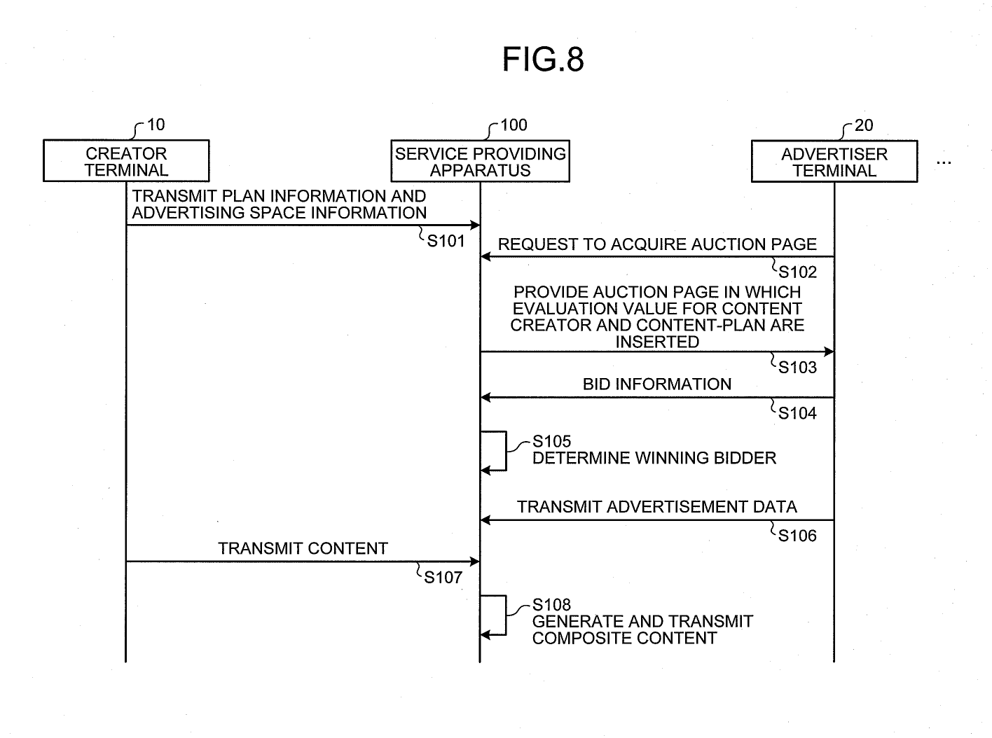

Next, a service providing process by the service providing system 1 according to the first embodiment will be described with reference to FIG. 8. FIG. 8 is a sequence diagram illustrating the service providing process by the service providing system 1 according to the first embodiment. Note that in FIG. 8, only one advertiser terminal 20 is illustrated, but practically, there is a plurality of advertiser terminals 20.

As illustrated in FIG. 8, the content creator transmits the plan information and the advertising space information to the service providing apparatus 100 using the creator terminal 10 (step S101). In this case, the service providing apparatus 100 stores the plan information and the advertising space information in the auction storage unit 121.

Note that the example of FIG. 8 has described the example in which the content creator transmits the plan information and the advertising space information at the same time. However, the content creator may transmit the plan information and the advertising space information at the different timing. For example, the content creator may transmit the advertising space information to the service providing apparatus 100 after transmitting the plan information. Furthermore, for example, the content creator may transmit the plan information and the advertising space information to the service providing apparatus 100 by inputting various kinds of information to the above-described submission site. In this case, the content creator may first input the plan information to the submission site and then input the advertising space information to the submission site on a different date or the like.

Subsequently, the service providing apparatus 100 receives the request for an auction page from the advertiser terminal 20 (step S102). For example, the service providing apparatus 100 receives the request for an auction page through the list page illustrated in FIG. 6. In this case, the service providing apparatus 100 provides an auction page on which content-plan of content is posted to the advertiser terminal 20 (step S103). Then, the service providing apparatus 100 receives the bid information including the bidding price from the advertiser terminal 20 through the auction page (step S104). In this manner, the service providing apparatus 100 receives bid information from the plurality of advertiser terminals 20.

Then, the service providing apparatus 100 determines a winning bidder based on the bid information received from the advertiser terminal 20 (step S105). For example, the service providing apparatus 100 determines an advertiser that is bidding the highest price at a date and time on which a period of time of holding an auction expired, as the winning bidder. Then, the service providing apparatus 100 manages the winning bid amount paid by the winning bidder. Thereafter, when the content creator has asked for payment of a production cost, the service providing apparatus 100 remits the billed amount to the content creator from the winning bid amount.

Furthermore, the winning bidder transmits advertisement data to the service providing apparatus 100 using the advertiser terminal 20 (step S106). Furthermore, when content has been created, the content creator transmits the content to the service providing apparatus 100 using the creator terminal 10 (step S107).

Then, the service providing apparatus 100 generates composite content by incorporating advertisement data received from the advertiser into the content received from the content creator, and transmits the generated composite content to the distribution server 30 (step S108).

### 5. Effects

As described above, the service providing apparatus 100 according to the first embodiment includes the calculating unit 142, the plan receiving unit 131, and the service providing unit 132. The calculating unit 142 calculates an evaluation value for a content creator that creates content. The plan receiving unit 131 receives plan information indicating content-plan planned by the content creator. The service providing unit 132 presents the evaluation value calculated by the calculating unit 142 and the plan information received by the plan receiving unit 131, and provides an auction service in which a right to display an advertisement on the content is a bid target.

As a result, even when an auction is held at the stage of planning content, the service providing apparatus 100 according to the first embodiment enables an advertiser that is a bidder to apprehend, for example, the credibility or the creating ability of the content creator, and thus can make the advertiser feel at ease about bidding. As a result, the service providing apparatus 100 can provide a service having an value-added to the advertiser.

Furthermore, in the service providing apparatus 100 according to the first embodiment, the calculating unit 142 calculates the evaluation value for the content creator based on a record of created content having created previously by the content creator. For example, the calculating unit 142 calculates a higher evaluation value for the content creator as the number of pieces of created content or the views in which created content is viewed by the user increases.

Accordingly, the service providing apparatus 100 according to the embodiment can calculate the evaluation value based on, for example, the creating ability or the planning ability of the content creator with a high degree of accuracy, and thus can provide a service having a high value-added to the advertiser.

### Second Embodiment

The first embodiment has described the example in which an evaluation value for a content creator is calculated based on content having created previously. A second embodiment will describes an example in which an evaluation value for a content creator is dynamically calculated according to a creation status of content being planned.

### 1. Structure of Service Providing Apparatus

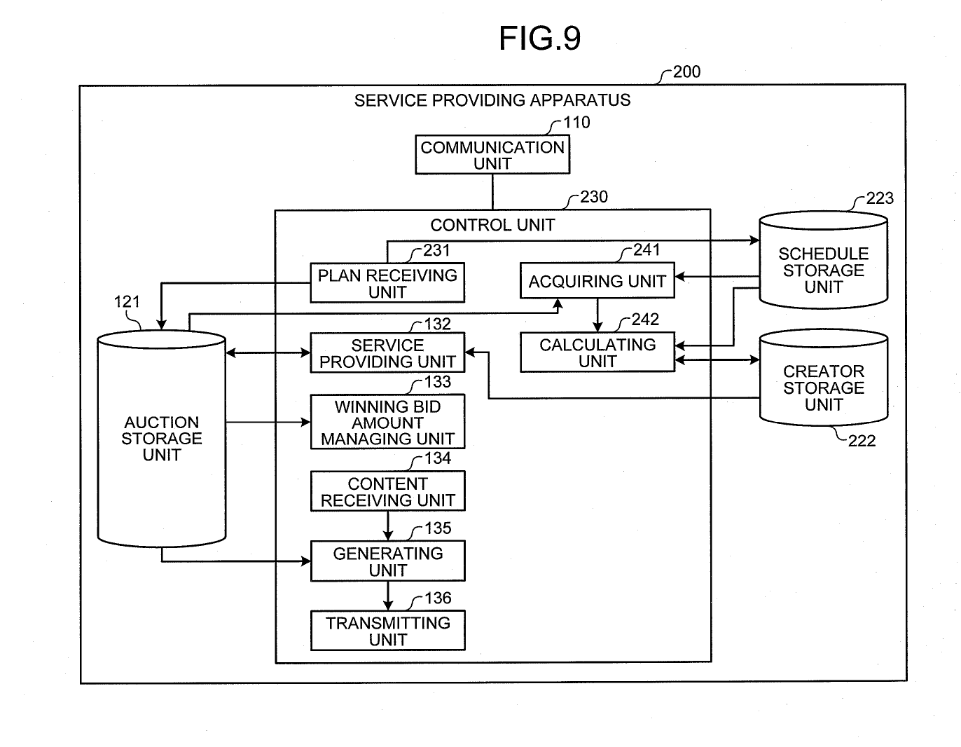

First, a structure of a service providing apparatus 200 according to the second embodiment will be described with reference to FIG. 9. FIG. 9 is a diagram illustrating an exemplary structure of the service providing apparatus 200 according to the second embodiment. As illustrated in FIG. 9, the service providing apparatus 200 includes a creator storage unit 222, a schedule storage unit 223, and a control unit 230.

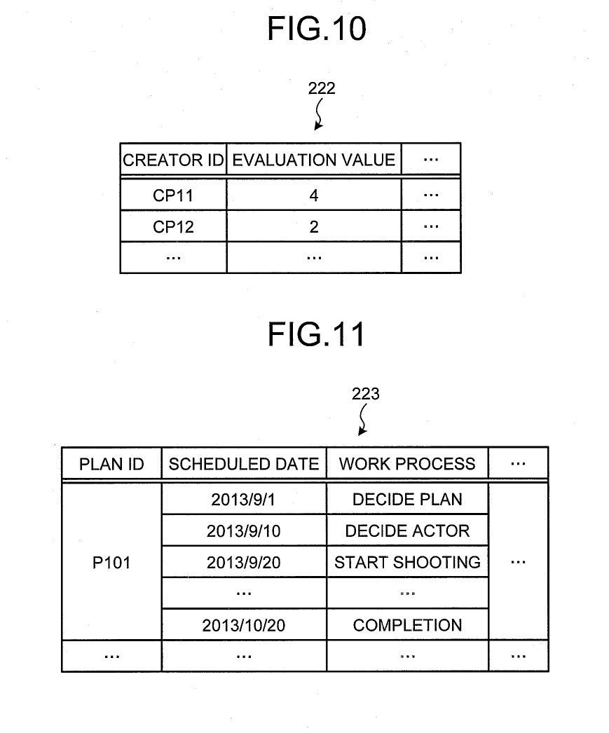

The creator storage unit 222 stores an evaluation value for a content creator for each content creator. FIG. 10 illustrates an example of the creator storage unit 222 according to the second embodiment. As illustrated in FIG. 10, the creator storage unit 222 includes items such as a “creator ID” and an “evaluation value”. That is, the creator storage unit 222 does not include items such as the “created content” and the “views”, compared to the creator storage unit 122 illustrated in FIG. 5.

The schedule storage unit 223 stores schedule information related to a work schedule of content at a planning stage. FIG. 11 illustrates an example of the schedule storage unit 223 according to the second embodiment. As illustrated in FIG. 11, the schedule storage unit 223 includes items such as a “plan ID”, a “scheduled date”, and a “work process”. The “plan ID” corresponds to the plan ID illustrated in FIG. 4. The “scheduled date” indicates a scheduled date on which the work process ends. The “work process” indicates a process necessary in creating content corresponding to plan information.

That is, FIG. 11 illustrates an example in which a plan of content identified by a plan ID “P101” is scheduled to be decided by Sep. 1, 2013. Furthermore, FIG. 11 illustrates an example in which an actor of the content is scheduled to be decided by Sep. 10, 2013. Furthermore, FIG. 11 illustrates an example in which shooting of the content is scheduled to be started by Sep. 20, 2013. Furthermore, FIG. 11 illustrates an example in which the content is scheduled to be completed by Oct. 20, 2013. Note that, as will be described later, the schedule information stored in the schedule storage unit 223 is transmitted by the content creator.

Referring back to FIG. 9, the control unit 230 includes a plan receiving unit 231, an acquiring unit 241, and a calculating unit 242 as illustrated in FIG. 9. The plan receiving unit 231 receives the schedule information in addition to the plan information and advertising space information from the content creator. Specifically, the plan receiving unit 231 receives schedule information including a combination of a work process necessary in creating content corresponding to the plan information and the scheduled date on which the work process ends. Then, the plan receiving unit 231 stores the schedule information received from the content creator in the schedule storage unit 223 in association with the plan ID.

Note that the plan receiving unit 231 may provide a submission site for inputting the schedule information to the content creator. For example, the plan receiving unit 231 provides a submission site for inputting a work process (referred to as a milestone or the like in some cases) in content creation, a scheduled date and time on which the work process ends, and the like. In this case, the plan receiving unit 231 receives various kinds of information input to the submission site as the schedule information.

The acquiring unit 241 acquires progress information related to a content creation progress from a content creator that is planning content creation. Specifically, when the present date and time is the scheduled date stored in the schedule storage unit 223, the acquiring unit 241 acquires the work process corresponding to the scheduled date from the schedule storage unit 223, and acquires the plan ID stored in the schedule storage unit 223 in association with the scheduled date. Then, the acquiring unit 241 specifies a creator ID corresponding to the plan ID acquired from the schedule storage unit 223 with reference to the auction storage unit 121. As a result, the acquiring unit 241 specifies a content creator that is planning content creation. Then, the acquiring unit 241 notifies a creator terminal 10 used by the specified content creator of a transmission request for requesting transmission of the progress information. Specifically, the acquiring unit 241 makes a request to transmit an end date and time of the work process acquired from the schedule storage unit 223 as described above. In this case, the content creator transmits the progress information including the end date and time of the work process to the service providing apparatus 200 using the creator terminal 10. Note that when the work process has not ended, the content creator transmits the progress information indicating that the work process has not ended to the service providing apparatus 200. In this manner, the acquiring unit 241 acquires the progress information from the creator terminal 10.

Note that the acquiring unit 241 may provide a progress input site for inputting the progress information to the content creator. For example, the acquiring unit 241 delivers a progress input web page including a display field on which the scheduled date and the work process stored in the schedule storage unit 223 are displayed and an input space for inputting an end date and time for each work process to the creator terminal 10. In this case, the acquiring unit 241 acquires various kinds of information input to the progress input web page as the progress information.

The calculating unit 242 calculates the evaluation value for the content creator based on the progress information acquired by the acquiring unit 241 and various kinds of information stored in the schedule storage unit 223. Specifically, when the progress information is acquired by the acquiring unit 241, the calculating unit 242 compares the end date and time included in the progress information with the scheduled date stored in the schedule storage unit 223. As a result, the calculating unit 242 determines whether or not the content creation by the content creator is progressing as scheduled. Then, the calculating unit 242 calculates a low evaluation value as the content creation progress is delayed, and calculates a high evaluation value as the content creation is progressing earlier than the scheduled date. This is because it can be said that the content creator that is proceeding with content creation as initially scheduled has high credibility.

In this manner, the calculating unit 242 calculates the evaluation value for the content creator each time the progress information is acquired by the acquiring unit 241, and stores the calculated evaluation value in the creator storage unit 222. That is, the calculating unit 242 according to the second embodiment sequentially calculates an evaluation value for a content creator while an auction is being held. Thus, the service providing unit 132 according to the second embodiment posts an evaluation value that possibly changes during an auction is held, on an auction page.

### 2. Service Providing Process

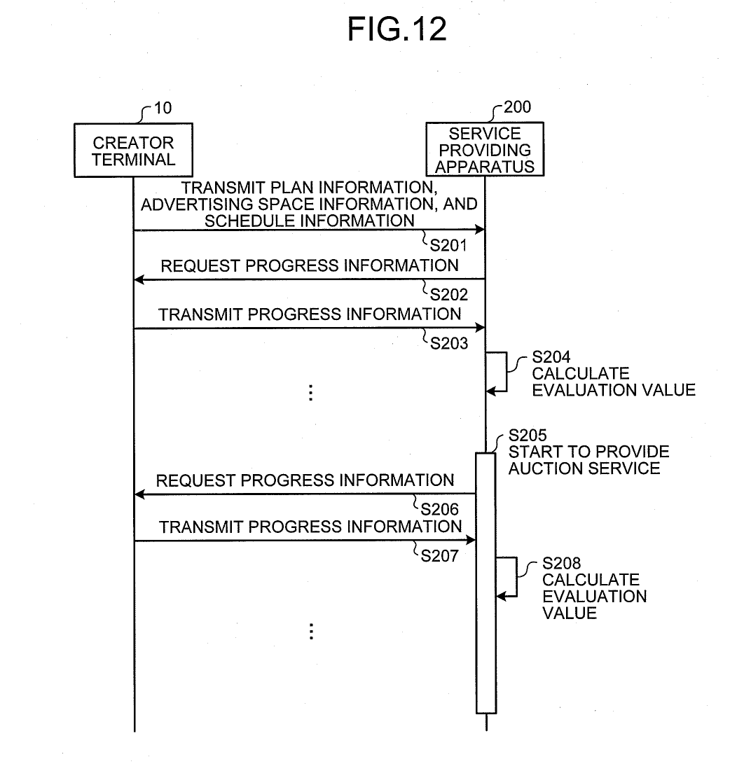

Next, a service providing process by a service providing system 1 according to the second embodiment will be described with reference to FIG. 12. FIG. 12 is a sequence diagram illustrating the service providing process by the service providing system 1 according to the second embodiment.

As illustrated in FIG. 12, the content creator transmits the plan information, the advertising space information, and the schedule information to the service providing apparatus 200 using the creator terminal 10 (step S201). In this case, the service providing apparatus 200 stores the plan information and the advertising space information in the auction storage unit 121, and stores the schedule information in the schedule storage unit 223. Note that the content creator may transmit the plan information, the advertising space information, and the schedule information at the different timing.

Subsequently, when the present date and time is the scheduled date stored in the schedule storage unit 223, the service providing apparatus 200 requests the creator terminal 10 to transmit the progress information (step S202). Accordingly, the creator terminal 10 transmits the progress information to the service providing apparatus 200 according to an operation of the content creator (step S203). Then, the service providing apparatus 200 calculates the evaluation value for the content creator based on the scheduled date stored in the schedule storage unit 223 and the progress information received from the creator terminal 10 (step S204). Then, the service providing apparatus 200 updates the evaluation value stored in the creator storage unit 222 to the evaluation value calculated in step S204. Then, the service providing apparatus 200 repeatedly performs the process of requesting the progress information, the process of receiving the progress information, and the process of calculating the evaluation value each time the present date and time becomes the scheduled date stored in the schedule storage unit 223.

Subsequently, when a date and time on which an auction is held comes, the service providing apparatus 200 starts to provide an auction service (step S205). Specifically, when the request for an auction page is received from an advertiser terminal 20, the service providing apparatus 200 provides an auction page to the advertiser terminal 20.

Then, even while the auction service is being provided, each time the present date and time becomes the scheduled date stored in the schedule storage unit 223, the service providing apparatus 200 repeatedly performs the process of requesting the progress information, the process of receiving the progress information, and the process of calculating the evaluation value as described above (step S206 to S208).

### 3. Effects

As described above, the service providing apparatus 200 according to the second embodiment includes the plan receiving unit 231, the acquiring unit 241, and the calculating unit 242. The plan receiving unit 231 receives the schedule information related to the work schedule of content. The acquiring unit 241 acquires the progress information related to creation of content planned by the content creator. The calculating unit 242 calculates the evaluation value for the content creator based on the schedule information received by the plan receiving unit 231 and the progress information acquired by the acquiring unit 241.

For example, the plan receiving unit 231 receives a combination of a work process necessary in creating content corresponding to the plan information and a scheduled date on which the work process ends as the schedule information. Furthermore, the acquiring unit 241 acquires an end date of the work process corresponding to the scheduled date for each scheduled date included in the schedule information as the progress information. Furthermore, the calculating unit 242 calculates a lower evaluation value for the content creator as the end date acquired by the acquiring unit 241 is delayed later than the scheduled date received by the plan receiving unit 231.

As a result, the service providing apparatus 200 according to the second embodiment can calculate the evaluation value based on the credibility of the content creator with a high degree of accuracy. For example, the service providing apparatus 200 can calculate a higher evaluation value for a content creator that is proceeding with content creation as schedule, and calculate a lower evaluation value for a content creator that delays content creation or a content creator that is likely to give up content creation. Then, the service providing apparatus 200 can provide a service having a high value-added by presenting the thus calculated evaluation value to an advertiser.

### 4. Modified Example

The example has been described in which the above-described service providing apparatus 200 updates the evaluation value for the content creator according to the progress status of content being planned. However, the calculating unit 242 of the service providing apparatus 200 may calculate the evaluation value for the content creator based on a record of the progress in content having created previously by the content creator. In this case, the schedule storage unit 223 illustrated in FIG. 11 stores an end date on which the work process has actually ended for each work process. Furthermore, the schedule storage unit 223 stores various kinds of information related to created content as history information. Then, when the plan information is received by the plan receiving unit 231, the calculating unit 242 compares the scheduled date stored in the schedule storage unit 223 with the end date, and determines whether or not content having created previously has been created as scheduled. Then, the calculating unit 242 calculates a higher evaluation value for a content creator that has created content as scheduled or a content creator that has created content earlier than a schedule, and calculates a lower evaluation value for a content creator that has created content later than a schedule. As described above, the calculating unit 242 may calculate the evaluation value for each content creator based on a previous creation record.

Furthermore, the calculating unit 242 may calculate a content delivery rate for each content creator. Specifically, the calculating unit 242 calculates the delivery rate for each content creator by dividing the number of times at which content has been received by the content receiving unit 134 by the number of times at which the plan information has been received by the plan receiving unit 231. Then, the service providing unit 132 posts the delivery rate calculated by the calculating unit 242 on the auction page. Furthermore, the service providing unit 132 may post information related to the content creator on the auction page. For example, the service providing unit 132 may post a uniform resource locator (URL) for accessing content having created previously by the content creator or a URL to a web page in which the content creator is introduced.

### Third Embodiment

A third embodiment will describe an example in which an evaluation value for a content creator is calculated based on consistency between composite content to be transmitted to a distribution server 30 and content-plan or the like.

1. Structure of Service Providing Apparatus

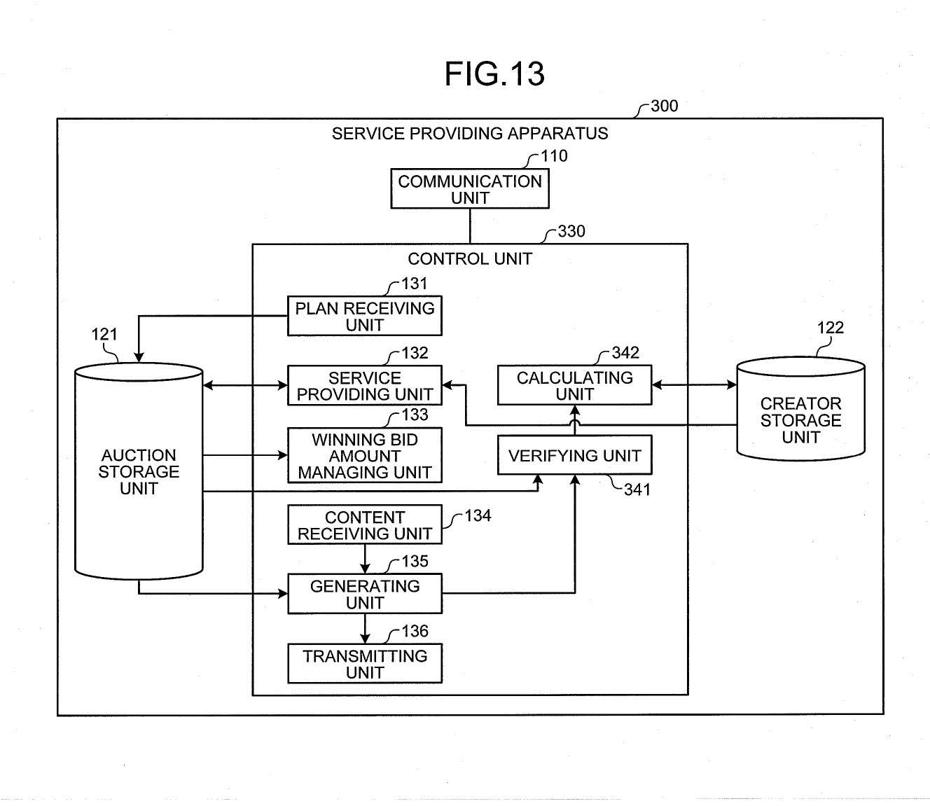

First, a structure of a service providing apparatus 300 according to the third embodiment will be described with reference to FIG. 13. FIG. 13 is a diagram illustrating an exemplary structure of the service providing apparatus 300 according to the third embodiment. As illustrated in FIG. 13, a control unit 330 of the service providing apparatus 300 includes a verifying unit 341 and a calculating unit 342.

The verifying unit 341 verifies consistency between composite content generated by a generating unit 135 and the content-plan indicated by plan information. Specifically, when the composite content is generated by the generating unit 135, the verifying unit 341 verifies whether or not content of the generated composite content matches with the content-plan and advertising space information stored in an auction storage unit 121.

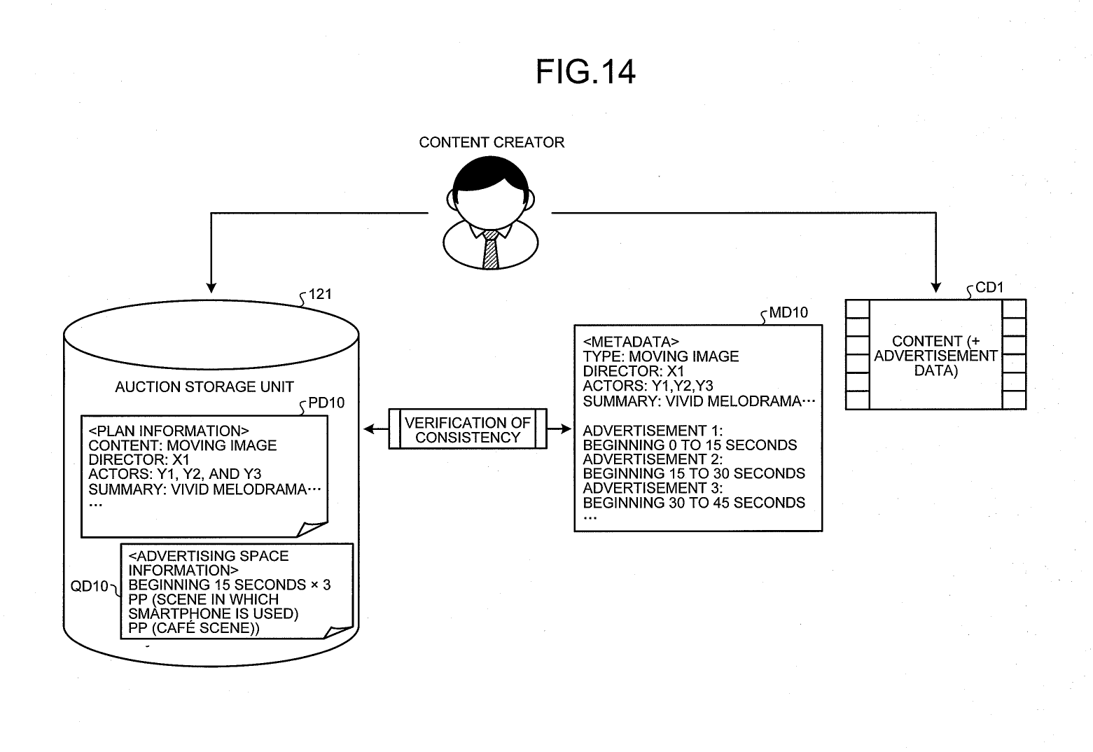

FIG. 14 illustrates an exemplary verification process performed by the verifying unit 341 according to the third embodiment. In the example illustrated in FIG. 14, the plan receiving unit 131 receives plan information PD10 and advertising space information QD10, and stores the plan information PD10 and the advertising space information QD10 in the auction storage unit 121. Furthermore, the generating unit 135 generates composite content CD1 in which advertisement data received from a winning bidder is incorporated into content created by a content creator. Metadata MD10 indicating content of a moving image is given to the composite content CD1. In the case of the example of FIG. 14, the metadata MD10 includes a type of content, information related to a director and an actor, or information related to a reproduction position of an advertising space.

In this state, the verifying unit 341 analyzes the metadata MD10, and extracts a keyword corresponding to each item such as a type of content, a director, an actor, and a reproduction position of an advertising space. For example, when the metadata MD10 is described in a markup language, the verifying unit 341 can easily extract the keyword corresponding to each item from the metadata MD10. Then, the verifying unit 341 verifies a degree of consistency between the plan information PD10 and the advertising space information QD10 stored in the auction storage unit 121 and the keyword extracted from the metadata MD10 for each item.

Note that examples of the items for which identity is verified by the verifying unit 341 include a “type of content”, “content-plan (a director, an actor, a summary, and the like)”, the “number of advertising spaces”, a “reproduction position of advertising space”, a “reproduction time of advertising space”, and a “size of advertising space”. Furthermore, for example, when the plan information includes a creation time limit of content, the verifying unit 341 may verify whether or not content has been created in a time limit.

The calculating unit 342 calculates the evaluation value for the content creator based on the verification result by the verifying unit 341. Specifically, the calculating unit 342 calculates a high evaluation value as a degree of consistency for each item verified by the verifying unit 341 increases, and calculates a low evaluation value as a degree of consistency for each item decreases. This is because it can be said that a content creator that has created content as initially planned has high credibility.

Note that the verifying unit 341 may accumulate record information indicating whether or not content having a consistency with the content-plan or the advertising space information has been generated, for each content creator. Then, the calculating unit 342 may calculate the evaluation value for the content creator based on the record information accumulated by the verifying unit 341.

Furthermore, when the number of items that do not match in the keyword in the example of FIG. 14 is a predetermined threshold value or more, the above-described verifying unit 341 may determine that composite content does not match with the content-plan or the advertising space information. In this case, the verifying unit 341 may give a notification indicating that there is no consistency to a creator terminal 10 of the content creator without outputting the composite content to the transmitting unit 136 and then end the process. Furthermore, when the verifying unit 341 determines that there is no consistency, a winning bid amount managing unit 133 may refund a winning bid amount to a winning bidder.

Furthermore, the service providing unit 132 may give a penalty to a content creator that has previously created content having no consistency more times than the predetermined number of times. For example, the service providing unit 132 may give a penalty of inhibiting a contribution of the plan information and the advertising space information, a penalty of stopping the distribution server 30 to deliver created content to a user terminal 40, or the like.

2. Effects

As described above, the service providing apparatus 300 according to the third embodiment includes the generating unit 135, the verifying unit 341, and the calculating unit 342. The generating unit 135 generates composite content in which content created by the content creator and advertisement data corresponding to an advertiser that has made a successful bid for a right to display an advertisement on content are incorporated. The verifying unit 341 verifies a degree of consistency between the composite content generated by the generating unit 135 and the content-plan indicated by the plan information. The calculating unit 342 calculates the evaluation value for the content creator based on the verification result obtained by the verifying unit 341.

As a result, the service providing apparatus 300 according to the third embodiment can calculate the evaluation value based on the credibility of the content creator. For example, the service providing apparatus 300 can calculate a higher evaluation value for a content creator that has created content matching the plan information presented at a planning stage, and can calculate a lower evaluation value for a content creator that has created content deviating from the plan information. Then, the service providing apparatus 300 can provide a service having a high value-added by presenting the thus calculated evaluation value to an advertiser.

### Fourth Embodiment

A fourth embodiment will describe an example in which an evaluation value for a content creator is dynamically calculated based on auction information related to an auction having held previously.

1. Structure of Service Providing Apparatus

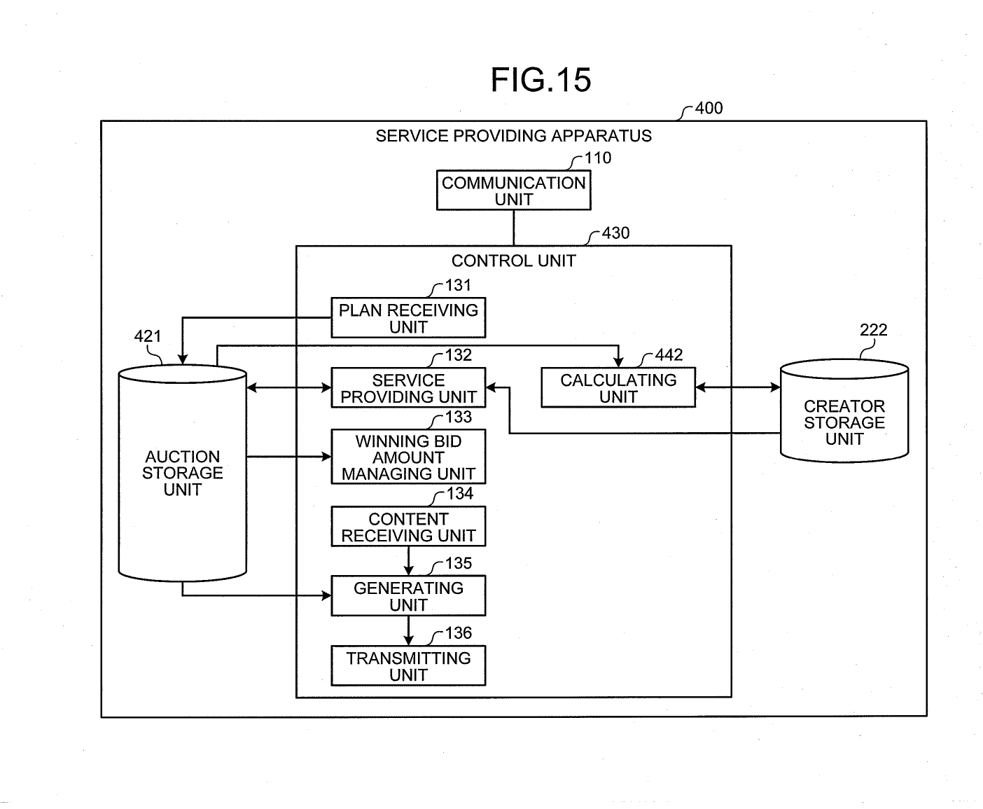

First, a structure of a service providing apparatus 400 according to the fourth embodiment will be described with reference to FIG. 15. FIG. 15 is a diagram illustrating an exemplary structure of the service providing apparatus 400 according to the fourth embodiment. As illustrated in FIG. 15, the service providing apparatus 400 includes a creator storage unit 222, an auction storage unit 421, and a control unit 430. The creator storage unit 222 is the same as the example illustrated in FIG. 10.

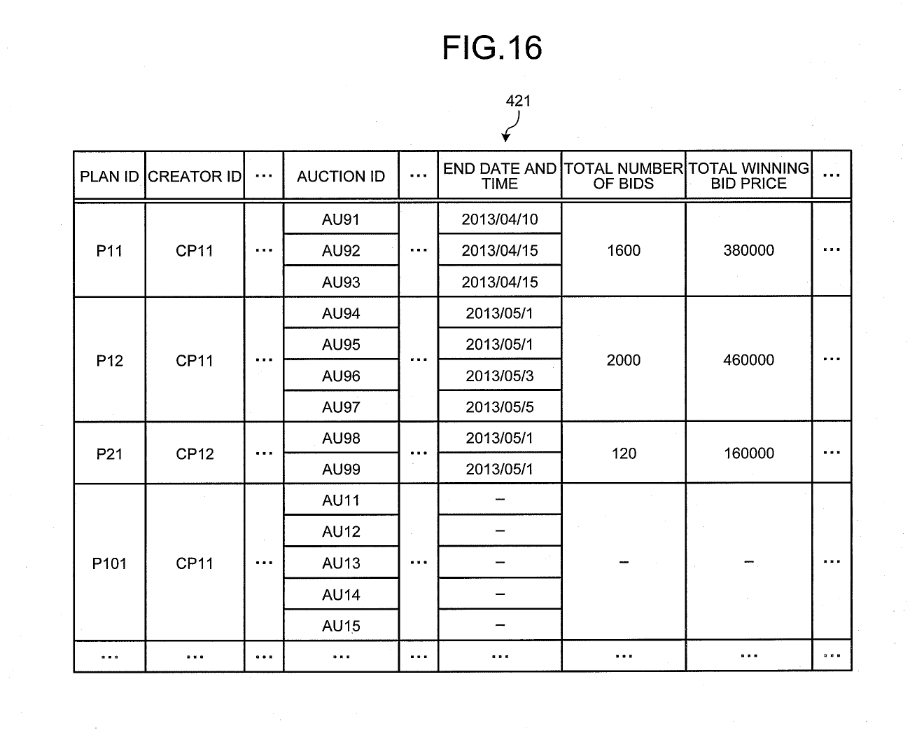

FIG. 16 illustrates an example of the auction storage unit 421 according to the fourth embodiment. As illustrated in FIG. 16, the auction storage unit 421 stores information such as the “total number of bids” and a “total winning bid price” as an example of auction information. Note that although not illustrated in FIG. 16, the auction storage unit 421 also stores the “content-plan”, the “advertising space information”, the “auction period”, the “current price”, and the “bidder ID” which are illustrated in FIG. 4.

The “total number of bids” indicates a sum of the numbers of bids that have been made in auctions corresponding to a plan ID. The “total winning bid price” indicates a total amount of the winning bid price in auctions corresponding to the plan ID. The “total number of bids” and the “total winning bid price” are stored by the service providing unit 132 after all auctions corresponding to the plan ID end. FIG. 16 illustrates an example in which auctions corresponding to plan IDs “P11”, “P12”, and “P21” have ended, and auctions corresponding to a plan ID “P101” do not end. That is, the auction storage unit 421 illustrated in FIG. 16 stores various kinds of information corresponding to the plan ID “P11”, “P12”, and “P21” as history information.

The control unit 430 includes a calculating unit 442. The calculating unit 442 calculates the evaluation value for the content creator based on the auction information stored in the auction storage unit 421. Then, the calculating unit 442 stores the calculated evaluation value in the creator storage unit 222. Here, the calculation process by the calculating unit 442 will be described using a few examples.

For example, the calculating unit 442 acquires auction information related to an auction held for a plan having previously made by a content creator from the auction storage unit 421 for each content creator. Specifically, the calculating unit 442 acquires the total number of bids as the auction information. Then, the calculating unit 442 calculates a higher evaluation value for the content creator as the total number of bids increases. In the case of the example of FIG. 16, the calculating unit 442 specifies the plan IDs “P11” and “P12” as the plans having previously made by a content creator CP11. Then, the calculating unit 442 acquires the total number of bids “1600” corresponding to the plan ID “P11” and the total number of bids “2000” corresponding to the plan ID “P12”. Then, the calculating unit 442 calculates the evaluation value for the content creator CP11 based on an average value “1800” of both total numbers of bids. For example, the calculating unit 442 holds a threshold value of the total number of bids for each stage of the evaluation value, and uses an evaluation value corresponding to a threshold value which the average value “1800” of the total numbers of bids exceeds as the evaluation value for the content creator CP11. Similarly, the calculating unit 442 calculates the evaluation value for the content creator CP12.

Furthermore, the calculating unit 442 is not limited to the above example, and may calculate a higher evaluation value for the content creator as a total winning bid price increases. In the case of the example of FIG. 16, the calculating unit 442 specifies the plan IDs “P11” and “P12” as the plans having previously made by the content creator CP11. Then, the calculating unit 442 acquires a total winning bid price “380000” corresponding to the plan ID “P11” and a total winning bid price “460000” corresponding to the plan ID “P12”. Then, the calculating unit 442 calculates the evaluation value for the content creator CP11 based on an average value “420000” of both the total winning bid prices. For example, the calculating unit 442 holds a threshold value of a total winning bid price for each stage of the evaluation value, and uses an evaluation value corresponding to a threshold value which the average value “420000” of the total winning bid prices exceeds as the evaluation value for the content creator CP11. Similarly, the calculating unit 442 calculates the evaluation value for the content creator CP12.

2. Effects

As described above, in the service providing apparatus 400 according to the fourth embodiment, the calculating unit 442 calculates an evaluation value for a content creator based on the auction information including the number of bids or the winning bid price in an auction related to a right to display an advertisement on content having planned previously by the content creator.

Accordingly, the service providing apparatus 400 according to the fourth embodiment can calculate an evaluation value for a content creator based on an auction having held previously with a high degree of accuracy. For example, when content-plan is excellent, content is expected to be viewed by many users, and thus the number of bids or the winning bid price of an auction tends to increase. That is, the service providing apparatus 400 can calculate a high evaluation value for a content creator that has presented excellent plan information previously, using the auction information related to the auction having held previously. Then, the service providing apparatus 400 can provide a service having a high value-added by presenting the thus calculated evaluation value to an advertiser.

### Fifth Embodiment

A fifth embodiment will describe an example in which the views in which content being planned is viewed by a user is predicted, and an evaluation value for a content creator is calculated according to the prediction result. Note that hereinafter, the number of times at which content is viewed by the user is described in some cases as “the number of PV (page view)”. Furthermore, hereinafter, a predicted value of the number of PV is described in some cases as “the predicted number of PV”.

### 1. Structure of Service Providing Apparatus

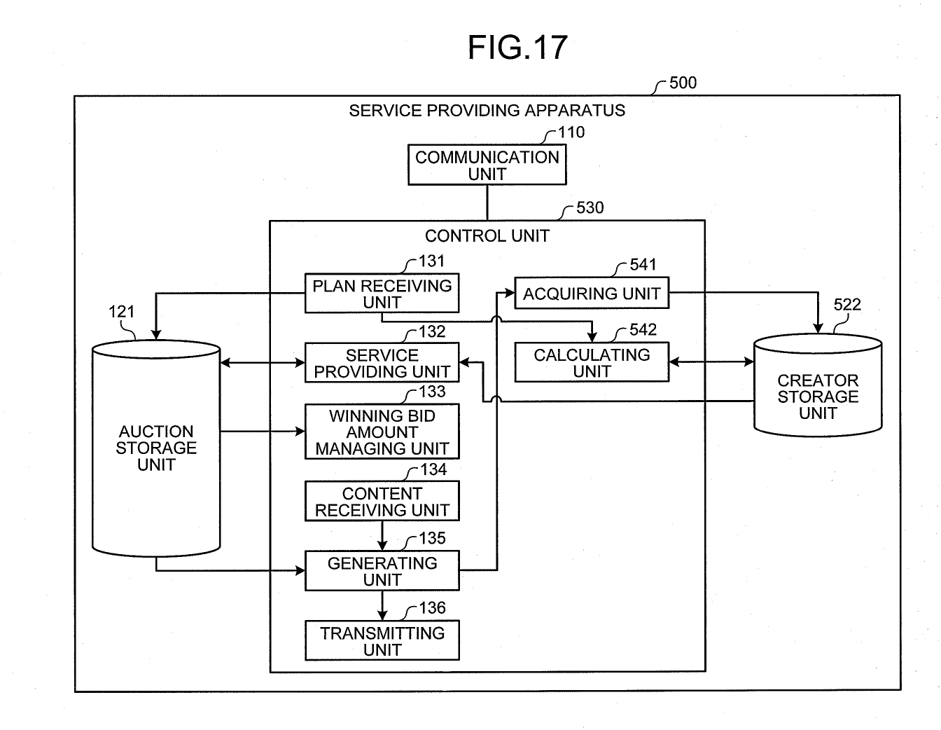

First, a structure of a service providing apparatus 500 according to the fifth embodiment will be described with reference to FIG. 17. FIG. 17 is a diagram illustrating an exemplary structure of the service providing apparatus 500 according to the fifth embodiment. As illustrated in FIG. 17, the service providing apparatus 500 includes a creator storage unit 522 and a control unit 530.

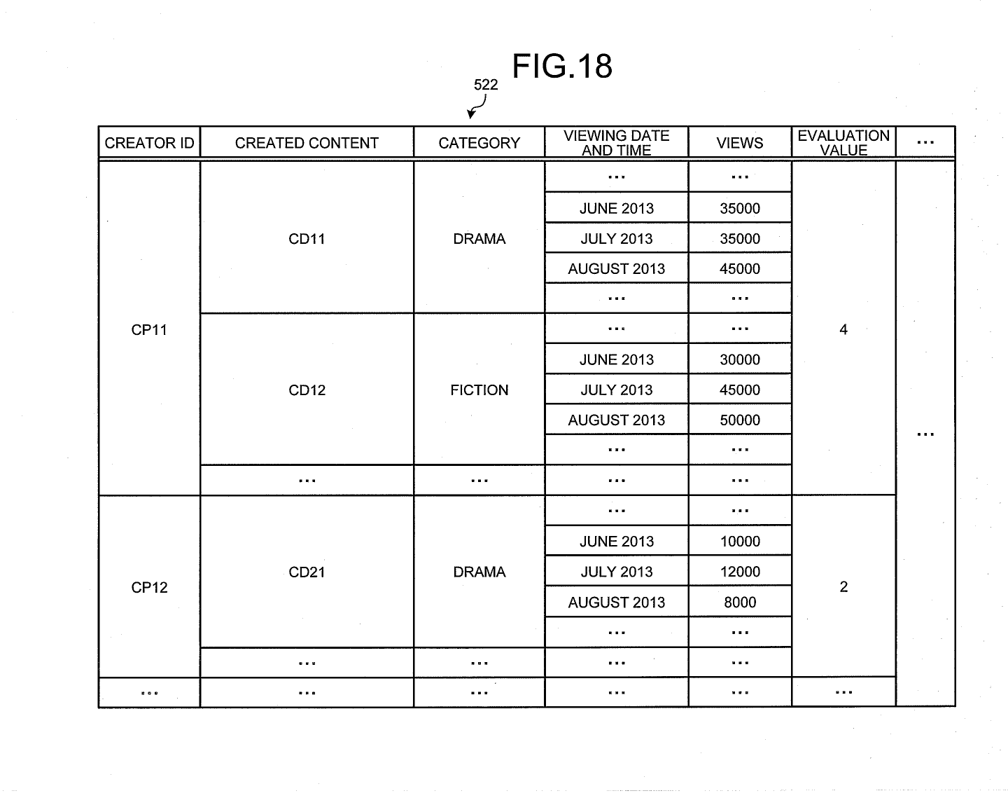

The creator storage unit 522 stores various kinds of information related to content having created previously by the content creator. FIG. 18 illustrates an example of the creator storage unit 522 according to the fifth embodiment. As illustrated in FIG. 18, the creator storage unit 522 includes items such as “creator ID”, “created content”, “category”, “viewing date and time”, “views”, and “evaluation value”.

The “creator ID” corresponds to the creator ID illustrated in FIG. 5. The “created content” corresponds to the created content illustrated in FIG. 5. The “category” indicates a category to which the created content belongs. Examples of the category of the created content include a drama, a fiction, and an animation. Note that, for example, a content category is included in plan information and set to the content creator. However, a content category may be set by an administrator of a service providing apparatus 500 or a distribution server 30 that has checked finished content. The “viewing date and time” indicates a date and time on which content was viewed. In other word, the “viewing date and time” indicates a date and time on which content was browsed. In the example of FIG. 18, information indicating a year and a month among a year, a month, a date, a time, a minute, and a second is stored in the “viewing date and time”. The “views” indicates the number of times at which content has been viewed. In other words, the “views” indicates the number of times in which content (actually, composite content) has been delivered to a user terminals 40 by the distribution server 30. FIG. 18 illustrates an example in which the monthly views is stored in the “views”. The “evaluation value” corresponds to the evaluation value illustrated in FIG. 5.

That is, FIG. 18 illustrates an example in which content “CD11” and content “CD12” have been created previously by a content creator C211. Furthermore, FIG. 18 illustrates an example in which the content “CD11” is content (for example, a moving image) related to a drama. Furthermore, FIG. 18 illustrates an example in which the content “CD11” was viewed 35,000 times on June 2013, viewed 35,000 times on July 2013, and viewed 45,000 times on August 2013.

Referring back to FIG. 17, the control unit 530 includes an acquiring unit 541 and a calculating unit 542. The acquiring unit 541 stores composite content generated by a generating unit 135 in the created content of the creator storage unit 522 in association with the creator ID of the content creator, similarly to the acquiring unit 141 according to the first embodiment. Furthermore, the acquiring unit 541 periodically accesses the distribution server 30, and acquires the number of deliveries for each piece of composite content from the distribution server 30. Then, the acquiring unit 541 accumulates the number of deliveries for each piece of composite content acquired from the distribution server 30, and stores the views for each predetermined period of time (for example, one month) in the views of the creator storage unit 522.

The calculating unit 542 calculates the predicted number of PV of content being planned, and calculates the evaluation value for the content creator using the predicted number of PV. Here, when the plan information is received by a plan receiving unit 131, the calculating unit 542 according to the fifth embodiment is assumed to calculate the predicted number of PV of content being planned and calculate the evaluation value for the content creator. A process of calculating the predicted number of PV by the calculating unit 542 will be described below.

For example, the calculating unit 542 calculates the predicted number of PV of content corresponding to the plan information based on the views of content having created previously by the content creator that has transmitted the plan information. Specifically, the calculating unit 542 specifies created content corresponding to a creator ID of the content creator that has transmitted the plan information among pieces of created content stored in the creator storage unit 522. Then, the calculating unit 542 calculates the predicted number of PV of content being planned based on the views corresponding to the specified created content. For example, the calculating unit 542 calculates an average value of the views corresponding to the created content as the predicted number of PV. This is because the number of PV of content, which is created by the same content creator, is considered to be within a certain range.

The above-described calculation process will be described using the example of FIG. 18. Here, the plan information is assumed to be transmitted by the content creator CP11. In this case, the calculating unit 542 specifies created content “CD11” and “CD12” having a creator ID of “CP11”. Then, the calculating unit 542 calculates a sum “115000” of the numbers of views of the created content “CD11”, and a sum “125000” of the numbers of views of the created content “CD12”. Then, the calculating unit 542 calculates an average value “120000” of both sums as the predicted number of PV. Note that the calculating unit 542 may calculate a value obtained by subtracting a predetermined percentage from the average value of the views as the predicted number of PV.

Furthermore, for example, the calculating unit 542 calculates the predicted number of PV of content corresponding to the plan information based on the views of created content corresponding to the plan information received by the plan receiving unit 131 among all created content (that is, created content having created previously by various content creators as well as the content creator that has transmitted the plan information) stored in the creator storage unit 522. Specifically, the calculating unit 542 specifies created content that is identical in a content category included in the plan information, and calculates the prediction PV based on the views corresponding to the specified created content. This is because the number of PV of content that is identical in a category is likely to be within a certain range. For example, content related to a drama is considered to tend to be generally viewed about 100,000 times, and a content related to an animation is considered to tend to be generally viewed about 50,000 times.

The above-described calculation process will be described using the example of FIG. 18. Here, the content category included in the plan information is assumed to be a “drama”. In this case, the calculating unit 542 specifies the created content “CD11” and “CD21” having the category of a “drama”. Then, the calculating unit 542 calculates a sum “115000” of the numbers of views of the created content “CD11”, and calculates a sum “30000” of the numbers of views of the created content “CD21”. Then, the calculating unit 542 calculates an average value “72500” of both sums as the predicted number of PV.

In this manner, when the plan information is received by the plan receiving unit 131, the calculating unit 542 calculates the predicted number of PV of content corresponding to the plan information. Then, the calculating unit 542 calculates a higher evaluation value for the content creator as the predicted number of PV of content increases. On the other hand, the calculating unit 542 calculates a lower evaluation value for the content creator as the predicted number of PV of content decreases.

### 2. Effects

As described above, in the service providing apparatus 500 according to the fifth embodiment, when the plan information is received by the plan receiving unit 131, the calculating unit 542 calculates the predicted number of PV of content corresponding to the plan information based on the plan information, and calculates a higher evaluation value for the content creator as the calculated predicted number of PV increases.

Accordingly, the service providing apparatus 500 according to the fifth embodiment can calculate the evaluation value based on the content-plan with a high degree of accuracy. Then, the service providing apparatus 500 can provide a service having a high value-added by presenting the thus calculated evaluation value to an advertiser.

### 3. Modified Example

The service providing apparatus 500 according to the above fifth embodiment may be carried out in various different modes other than the above embodiment. Now, other embodiment of the service providing apparatus 500 will be described below.

3-1. Technique of Calculating the Predicted Number of PV

The above fifth embodiment has described the example in which the service providing apparatus 500 calculates the predicted number of PV based on a prediction element, such as “views of created content matched with a content creator to content being planned” or “views of created content that matched with a category to content being planned”. However, the calculating unit 542 may calculate the predicted number of PV using a plurality of prediction elements.

For example, the calculating unit 542 may calculate the predicted number of PV based on “views of created content matched with a content creator to content being planned” and “views of created content matched with a category to content being planned. Hereinafter, description will be made about an example in which the calculating unit 542 generates a regression model (hereinafter, referred to as a “PV number model M1”) from both of the prediction elements, and calculates the predicted number of PV from the generated PV number model M1.

First, the calculating unit 542 generates the PV number model M1, which shows the predicted number of PV by the creator ID or the category, by performing regression analysis using the views stored in the creator storage unit 522 as a dependent variable (objective variable) and the creator ID or the category stored in the creator storage unit 522 as an independent variable (explanatory variable). For example, the PV number model M1 calculated by the calculating unit 542 is expressed by the following Expression (1).

pv=a0·x0+a1·x1 (1)

In the above Expression (1), “pv” indicates the views stored in the creator storage unit 522. Furthermore, “x0” indicates an average value of the views for each creator ID. In the case of the example of FIG. 18, the views of the created content “CD11” created by the content creator CP11 is “115000”, and the views of the created content “CD12” is “125000”. Thus, “x0” corresponding to the content creator CP11 becomes “120000”. Furthermore, “x1” indicates an average value of the views for each category. In the case of the example of FIG. 18, the views of the created content “CD11” corresponding to the category “drama” is “115000”, and the views of the created content “CD21” is “30000”. Thus, “x1” corresponding to the category “drama” becomes “72500”.

For example, in the case of the created content “CD11” illustrated in FIG. 18, the number of “pv” is “115000”. Furthermore, as in the above example, “x0” corresponding to the content creator CP11 is “120000”, and, “x1” corresponding to the category “drama” is “72500”. In this case, the above Expression (1) is expressed as in the following Expression (2).

pv=a0·x0+a1·x1 (1)

115000=a0·(120000)+a1·(72500) (2)

The calculating unit 542 also obtains the same expression as the above Expression (2) for the created content “CD12” and “CD21”. Then, the calculating unit 542 calculates “a0” and “a1” that approximately satisfy each expression by performing regression analysis on the expression corresponding to the respective created content, and generates the PV number model M1 by applying the calculated “a0” and “a1” to the above Expression (1).

Then, when the plan information is received by the plan receiving unit 131, the calculating unit 542 calculates the predicted number of PV using the PV number model M1 expressed in the above Expression (1). Specifically, the calculating unit 542 substitutes an average value of the views of created content corresponding to the content creator that has transmitted the plan information into “x0” of the above Expression (1). Furthermore, the calculating unit 542 substitutes an average value of the views of created content corresponding to a category included in the plan information into “x1” of the above Expression (1). As a result, the calculating unit 542 calculates the predicted number of PV of content indicated by the plan information.

As described above, the service providing apparatus 500 can calculate the predicted number of PV with a high degree of accuracy using a plurality of prediction elements. As a result, the service providing apparatus 500 can calculate the evaluation value for the content creator with a high degree of accuracy and thus provide a service having a high value-added.

Note that in the above Expression (1), a linear model has been described as an example, but the calculating unit 542 may use a “log linear” model as in the following Expression (3) rather than the linear model.

pv=1/{1+exp(−(a0·x0+a1·x1))} (3)

3-2. Update (1) of Evaluation Value

Furthermore, the plan receiving unit 131 of the service providing apparatus 500 may receive the plan information from the content creator more than once in a stepwise manner. In this case, each time new plan information is received by the plan receiving unit 131, the calculating unit 542 may calculate the predicted number of PV based on the views of created content corresponding to the new plan information and update the evaluation value for the content creator. In this case, the service providing unit 132 presents the evaluation value for the content creator newly calculated by the calculating unit 542, and provides the auction service.

As described above, the service providing apparatus 500 may receive the plan information more than once in a stepwise manner. As a result, the service providing apparatus 500 can implement an auction service practical for the content creator. For example, even when content-plan is not sufficiently reviewed yet, the content creator transmits a brief version of the content-plan to the service providing apparatus 500 so that an auction can be held. Then, when the plan information is received in a stepwise manner, the service providing apparatus 500 calculates the predicted number of PV each time the plan information is received, and thus updates the evaluation value for the content creator. As a result, the service providing apparatus 500 can provide the evaluation value calculated with a high degree of accuracy to the advertiser (the bidder) each time the plan information is enriched.

3-3. Update (2) of Evaluation Value

Furthermore, the service providing apparatus 500 may update the predicted number of PV even when the plan information is not received in a stepwise manner. Specifically, the calculating unit 542 may periodically calculate the predicted number of PV based on the views of created content corresponding to auction information such as the number of bids or the highest bidding price while an auction service is being provided by the service providing unit 132. In this case, the service providing unit 132 presents the predicted number of PV newly calculated by the calculating unit 542, and provides the auction service.

This point will be specifically described. Note that here, the service providing apparatus 500 is assumed to include the auction storage unit 421 illustrated in FIG. 16 instead of the auction storage unit 121. The calculating unit 542 generates a regression model (hereinafter, assumed to be a “PV number model M2”) for calculating the predicted number of PV from the total number of bids or a total winning bid price based on an auction that has ended and that is stored in the auction storage unit 421. For example, the calculating unit 542 performs regression analysis, assuming that the views stored in the creator storage unit 522 is a dependent variable (an objective variable) and the total number of bids or a total winning bid price stored in the auction storage unit 421 is an independent variable (an explanatory variable), and thus generates the PV number model M2 representing the predicted number of PV by the total number of bids or a total winning bid price.

Then, the calculating unit 542 periodically updates the predicted number of PV using the PV number model M2 after provision of the auction service is held. Hereinafter, a process of calculating the predicted number of PV will be described using the plan ID “P101” illustrated in FIG. 16 as an example.

First, the calculating unit 542 calculates the total number of bids and a total amount of the current price (hereinafter, assumed to be a “total bidding price”) in auctions being held that are identified by auction IDs “AU11” to “AU15” corresponding to the plan ID “P101”. For example, the total number of bids and the total bidding price are temporarily stored in a predetermined storage unit (that may be the auction storage unit 421 or the like) by the service providing unit 132 while the auctions are being held.

Then, the calculating unit 542 predicts the total number of bids when the auctions being held have ended, based on the calculated total number of bids. Specifically, the calculating unit 542 predicts the total number of bids and a total winning bid price at the time when the auctions ended, based on a period of time of holding an auction and the number of days elapsed from a date of holding an auction to the present date. For example, the calculating unit 542 can predict the total number of bids from a period of time of holding an auction and the number of elapsed days based on a history of auctions having held previously. For example, the service providing apparatus 500 is assumed to store a period of time of holding an auction and the total number of bids and a total bidding price for each number of elapsed days in each auction as auction history information related to an auction having held previously. In this case, the calculating unit 542 can predict the total number of bids and a total bidding price when each auction being held has ended from a period of time of holding an auction and the number of elapsed in each auction being held by analyzing a relation between a period of time of holding an auction and the number of elapsed days and the total number of bids and a total bidding price stored in the auction history information. Then, the calculating unit 542 calculates the predicted number of PV by substituting the predicted total number of bids and total winning bid price into the PV number model M2.

As described above, the service providing apparatus 500 may sequentially calculate the predicted number of PV based on various kinds of information (the number of bids or the bidding price) related to the auction while the auction service is being provided and sequentially update the evaluation value for the content creator. Here, when content-plan is excellent, many users are expected to view content, and thus the number of bids and the winning bid price of an auction tend to increase. Then, when content-plan is actually excellent, many users generally tend to view content. That is, it can be said that the total number of bids and a total winning bid price predicted by the calculating unit 542 while an auction is being held indicates an evaluation index of content-plan. Then, it can be said that the above PV number model M2 indicates a relation between the evaluation index of the content-plan and the actual views. As a result, the calculating unit 542 can calculate the predicted number of PV with a high degree of accuracy using the PV number model M2, and can consequently calculate the evaluation value for the content creator with a high degree of accuracy.

3-4. Prediction Element Used in Prediction Process

Furthermore, the above fifth embodiment has described the example in which the service providing apparatus 500 uses the “views of created content matched with a content creator to content being planned”, the “views of created content matched with a category to content being planned”, the “total number of bids”, the “total winning bid price”, or the like as the prediction element used in calculating the predicted number of PV. However, the calculating unit 542 of the service providing apparatus 500 may calculate the predicted number of PV using a prediction element other than the above prediction elements.

For example, the calculating unit 542 may calculate the predicted number of PV using the prediction element such as the “views of created content matched with a director to content being planned”, the “views of created content matched with an actor to content being planned”, the “views of created content that is equivalent in a reproduction period of time to content being planned”, the “views of created content that is equivalent in the number of advertising spaces to be set to content being planned”, or the “views of created content that is similar in a position of an advertising space to be set to content being planned”. In this case, the calculating unit 542 generates the PV number model using these prediction elements, and calculates the predicted number of PV from the generated PV number model.

3-5. Prediction Accuracy of the Number of PV

Furthermore, the service providing apparatus 500 described above may calculate prediction accuracy that is a probability that the predicted number of PV will be correct. For example, the calculating unit 542 stores a predicted number of PV having calculated previously for created content having created previously, a prediction element having used in calculating the predicted number of PV previously, the actual number of PV of pieces of created content, an error number of PV that is an error between the predicted number of PV and the actual number of PV in a predetermined storage unit as prediction history information. Then, when the predicted number of PV of content being planned is calculated, the calculating unit 542 acquires the error number of PV corresponding to the prediction element used in calculating the predicted number of PV from the prediction history information. Then, the calculating unit 542 calculates the prediction accuracy of the predicted number of PV based on the error number of PV acquired from the prediction history information. For example, the calculating unit 542 calculates high prediction accuracy as an average value of the error number of PV acquired from the prediction history information decreases, and calculates low prediction accuracy as the average value of the error number of PV increases.

Then, when the evaluation value for the content creator is calculated using other evaluation element (for example, the views of created content) in addition to the predicted number of PV, the calculating unit 542 may adjust a weight of the predicted number of PV according to the prediction accuracy and then calculate the evaluation value. Specifically, the calculating unit 542 may increase the weight of the predicted number of PV as the prediction accuracy increases, decrease the weight of the predicted number of PV as the prediction accuracy decreases, and then calculate the evaluation value for the content creator using a plurality of evaluation elements. Accordingly, the evaluation value for the content creator can be calculated with a high degree of accuracy.

### Other Embodiment

The service providing systems 1 according to the above embodiments may be carried out in various different modes other than the above embodiments. Now, other embodiment of a service providing system 1 will be described. Note that hereinafter, other embodiment will be described using mainly a service providing apparatus 100 as an example, but other embodiment which will be described below can also be applied to service providing apparatuses 200, 300, 400, and 500.

1. Evaluation of User and Advertiser

The service providing apparatus 100 may calculate an evaluation value for a content creator based on an evaluation on a content creator by a user that has viewed created content having created previously by the content creator or an evaluation on a content creator by an advertiser having a right to display an advertisement on the created content. Specifically, an acquiring unit 141 accesses a distribution server 30, and thus acquires the user evaluation for each piece of composite content. Furthermore, the acquiring unit 141 acquires the user evaluation for each piece of composite content from an advertiser terminal 20. Then, the calculating unit 142 calculates the evaluation value for the content creator based on the evaluation on the content creator by the user and the advertiser. Accordingly, the service providing apparatus 100 can calculate the evaluation value for the content creator based on the evaluation on content with a high degree of accuracy.

2. Ranking Based on Evaluation Value

The above-described service providing apparatus 100 may rank the content creator based on the evaluation value. Then, the service providing unit 132 may receive rank information indicating a rank when the acquisition request of the list page W10 illustrated in FIG. 6 is received from the advertiser terminal 20. In this case, a service providing unit 132 generates the list page W10 illustrated in FIG. 6 based on various kinds of information related to content being planned by a content creator corresponding to the rank information received from the advertiser terminal 20. That is, the service providing unit 132 posts only various kinds of information related to content being planned by the content creator corresponding to a rank designated from the advertiser on the list page W10.

3. Introduction Page of Content Creator

Furthermore, the above-described service providing apparatus 100 may provide an introduction page on which user information of a content creator is posted. For example, the service providing unit 132 may provide an introduction page for a corresponding content creator to the advertiser terminal 20 when an anchor is placed on “CP11”, “CP12”, “CP13”, or the like displayed on a content creator column, and “CP11” or the like is clicked in the list page W10 illustrated in FIG. 6. Note that examples of the user information posed on the introduction page include a name, an age, content having created previously, and a career. Furthermore, the service providing apparatus 100 may provide a creation site for creating the introduction page to the content creator.

4. Type of Content

Furthermore, in the above embodiments, a moving image has been mainly described as an example of content. However, a type of content is not limited to a moving image. For example, the above-described content may be an application such as a game, a digital book, or a web page such as a weblog. For example, the content creator can use the above-described auction service when planning to create a game, a digital book, or a specialized web page.

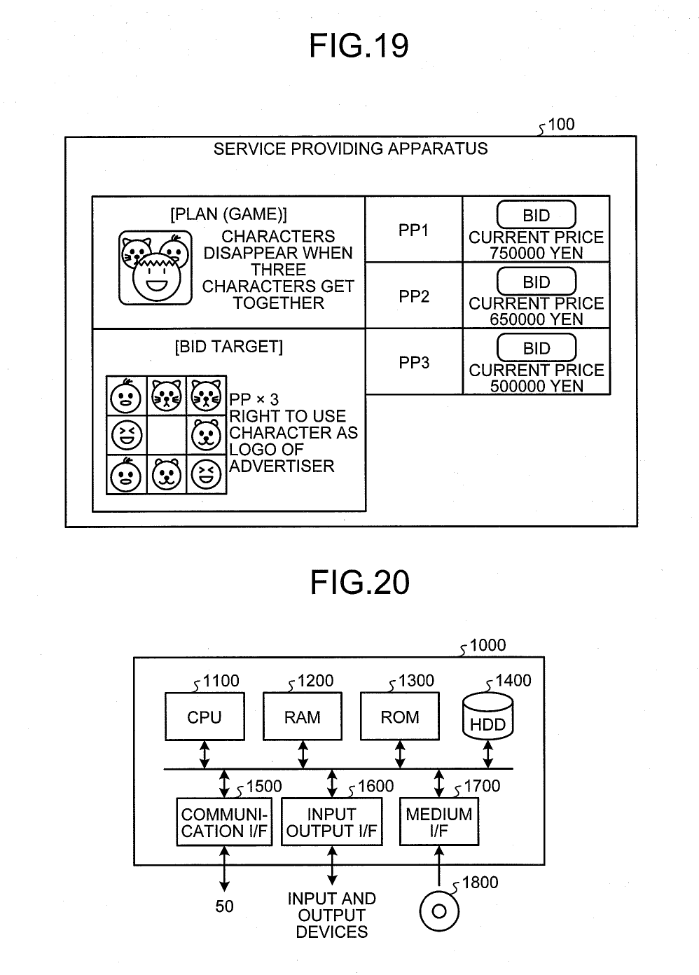

Here, FIG. 19 illustrates exemplary content according to other embodiment. FIG. 19 illustrates an example in which content is a game. In the example of FIG. 19, the content creator plans to create a game using icons of characters. Then, the content creator sets three icons among a plurality of types of icons as an advertising space. As described above, the above-described auction service can be applied even to content such as a game.

Note that in the case of the example of FIG. 19, similarly to product placement, the content creator receives an icon image for advertisement and the like from an advertiser that is a winning bidder, and creates a game using the received icon image and the like. Thus, the content creator can create composite content (a game in this example) including advertisement data.

5. Program

Furthermore, the service providing apparatuses 100, 200, 300, 400, and 500 according to the above embodiments are implemented, for example, by a computer 1000 having a structure illustrated in FIG. 20, for example. Hereinafter, description will be made using the service providing apparatus 100 as an example. FIG. 20 is a hardware structure diagram illustrating an example of the computer 1000 that implements a function of the service providing apparatus 100. The computer 1000 includes a CPU 1100, a RAM 1200, a ROM 1300, a HDD 1400, a communication interface (I/F) 1500, an input output I/F 1600, and a medium interface (I/F) 1700.

The CPU 1100 operates based on a program stored in the ROM 1300 or the HDD 1400, and controls each unit. The ROM 1300 stores, for example, a boot program executed by the CPU 1100 when the computer 1000 is activated, or a program depending on hardware of the computer 1000.

The HDD 1400 stores, for example, a program executed by the CPU 1100 and data used by the program. The communication interface 1500 receives data from other device via a communication network 50, sends the data to the CPU 1100, and transmits data generated by the CPU 1100 to other device via the communication network 50.

The CPU 1100 controls an output device such as a display and a printer and an input device such as a keyboard and a mouse through the input output interface 1600. The CPU 1100 acquires data from the input device through the input output interface 1600. The CPU 1100 outputs generated data to the output device through the input output interface 1600.

The medium interface 1700 reads a program or data stored in a recording medium 1800, and provides the read program or data to the CPU 1100 through the RAM 1200. The CPU 1100 loads the program onto the RAM 1200 from the recording medium 1800 through the medium interface 1700, and executes the loaded program. Examples of the recording medium 1800 include an optical recording medium such as a digital versatile disc (DVD) and a phase change rewritable disk (PD), a magneto optical recording medium such as a magneto-optical disk (MO), a tape medium, a magnetic recording medium, and a semiconductor memory.

For example, when the computer 1000 functions as the service providing apparatus 100 according to the embodiment, the CPU 1100 of the computer 1000 executes the program loaded onto the RAM 1200, and thus implements the function of the control unit 130. Furthermore, data in the auction storage unit 121 or the creator storage unit 122 is stored in the HDD 1400. The CPU 1100 of the computer 1000 reads the program from the recording medium 1800 and then executes the program, but as other example, the program may be acquired from other device via the communication network 50.

6. Others

Among the processes described in the above embodiment, some or all of the processes described as being automatically performed can also be manually performed, or some or all of the processes described as being manually performed can also be automatically performed by a known method. In addition, a process, a specific name, or information including various kinds of data or parameters described hereinabove or illustrated in the drawings can be arbitrarily changed unless set forth otherwise herein.

For example, various kinds of information illustrated in the figures are not limited to the illustrated information. Furthermore, for example, the above embodiments have described the example in which a plurality of advertising spaces are set to identical content, but a single advertising space may be set to identical content.

Furthermore, the above embodiments have described the example in which the content creator sets a reproduction position of an advertising space, a reproduction time, or the like in content. However, the service providing apparatus 100 may receive only the plan information from the content creator and may not receive the advertising space information. In this case, for example, the service providing apparatus 100 sets an advertising space of a predefined reproduction position or reproduction time in content.

Furthermore, the above embodiments have described the example in which the service providing apparatus 100 generates composite content, but the process of generating composite content may be performed by other device such as the distribution server 30. In this case, the service providing apparatus 100 illustrated in FIG. 3 may not include the generating unit 135 and the like.

Furthermore, for example, the above embodiments have described the example in which composite content including advertisement data incorporated into content is delivered to the user terminal 40, but the advertisement data may be delivered to the user terminal 40 through an advertising server (not illustrated in FIG. 2) (called an ad server or the like) each time content is displayed or played back by the user terminal 40. Specifically, the generating unit 135 of the service providing apparatus 100 may generate the composite content by incorporating access information (for example, a uniform resource locator (URL)) to the advertising server into an advertising space of content. In this case, the user terminal 40 accesses the advertising server based on the access information set to the advertising space. Then, when there is access from the user terminal 40, the advertising server delivers the advertisement data incorporated into the content to the user terminal 40. At this time, the advertising server selects advertisement data to be delivered based on, for example, a user attribute of an access source user. Then, the user terminal 40 causes the advertisement data acquired from the advertising server to be displayed on the advertising space of content. Furthermore, in the case of this example, the advertiser may transmit access information for accessing, for example, a moving image or a still image that is an advertisement to the service providing apparatus 100, as the advertisement data.

Furthermore, each component of each device illustrated in the drawings is conceptual one, and needs not be necessarily physically configured as illustrated in the drawings. That is, a specific mode of distribution or integration of each device is not limited to the illustrated one, and some or all thereof can be configured to be functionally or physically distributed or integrated by any unit according to various kinds of loads or usage. For example, the plan receiving unit 131 and the content receiving unit 134 illustrated in FIG. 3 may be integrated with each other. Furthermore, for example, the above-described service providing apparatus 100 may be integrated with the distribution server 30.

Furthermore, the above embodiments can be appropriately combined within a range in which processing content is not contradictory.

Furthermore, the above embodiments can be appropriately combined within a range in which processing content is not contradictory. For example, the above-described service providing apparatus 100 may calculate an overall evaluation value for the content creator using all or some of the evaluation elements described in the embodiments.

As above, some of the embodiments of the present disclosure have been described above in detail based on the drawings, but the above embodiments are exemplary, and the present invention can be carried out in other modes in which various kinds of modification or improvement are made based on knowledge of a person skilled in the art, including the aspects described in the disclosure of the invention.

Furthermore, “section, module, or unit” described above can be interpreted as “means”, “circuit”, or the like. For example, the plan receiving unit can be interpreted as plan receiving means or a plan receiving circuit.

According to an aspect of an embodiment, such an effect is obtained that a service having an value-added can be provided to an advertiser.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A service providing apparatus, comprising:
a calculating unit configured to calculate an evaluation value for a content creator that creates content;
a plan receiving unit configured to receive plan information indicating a plan of the content planned by the content creator; and
a providing unit configured to present the evaluation value calculated by the calculating unit and the plan information received by the plan receiving unit, and provide an auction service in which a bid target is a right to display an advertisement on the content.

2. The service providing apparatus according to claim 1,
wherein the calculating unit calculates the evaluation value for the content creator based on a record of created content having created in the past by the content creator.

3. The service providing apparatus according to claim 2,
wherein the calculating unit calculates a higher evaluation value for the content creator as the number of pieces of the created content increases or as the number of times, at which the created content is viewed by a user, increases.

4. The service providing apparatus according to claim 1, further comprising:
an acquiring unit configured to acquire progress information related to creation of the content planned by the content creator,
wherein the plan receiving unit further receives schedule information related to a work schedule of the content, and
the calculating unit calculates a higher evaluation value for the content creator as the content is being created as scheduled, based on the schedule information received by the plan receiving unit and the progress information acquired by the acquiring unit.

5. The service providing apparatus according to claim 4,
wherein the plan receiving unit receives a combination of a work process necessary in creating content corresponding to the plan information and a scheduled date on which the work process ends as the schedule information,
the acquiring unit acquires an end date of the work process corresponding to the scheduled date as the progress information for each scheduled date included in the schedule information, and
the calculating unit calculates a lower evaluation value for the content creator as the end date acquired by the acquiring unit is delayed later than the scheduled date received by the plan receiving unit.

6. The service providing apparatus according to claim 1,
wherein the calculating unit calculates the evaluation value for the content creator, based on whether or not created content having created previously by the content creator has been created as scheduled.

7. The service providing apparatus according to claim 1,
wherein the calculating unit calculates the evaluation value for the content creator, based on an evaluation on the content creator by a user that has viewed created content having created in the past by the content creator or an evaluation on the content creator by an advertiser having a right to display an advertisement on the created content.

8. The service providing apparatus according to claim 1, further comprising:
a generating unit configured to generate composite content in which content created by the content creator and advertisement data corresponding to an advertiser who has the right to display an advertisement on the content are incorporated; and
a verifying unit configured to verify consistency between the composite content generated by the generating unit and the plan of the content indicated by the plan information,
wherein the calculating unit calculates the evaluation value for the content creator based on a verification result by the verifying unit.

9. The service providing apparatus according to claim 1,
wherein the calculating unit calculates the evaluation value for the content creator, based on auction information including the number of bids or a winning bid price in an auction related to a right to display an advertisement on content having planned in the past by the content creator.

10. The service providing apparatus according to claim 1,
wherein when the plan information is received by the plan receiving unit, the calculating unit calculates, based on the plan information, the number of predicted views that is a predicted value of the number of times at which content corresponding to the plan information is viewed by a user, and calculates a higher evaluation value for the content creator as the calculated prediction value increases.

11. A service providing method executed by a computer, comprising:
calculating an evaluation value for a content creator that creates content;
receiving plan information indicating a plan of the content planned by the content creator; and
presenting the evaluation value calculated at the calculating and the plan information received at the receiving and providing an auction service in which a bid target is a right to display an advertisement on the content.

12. A non-transitory computer-readable storage medium with an executable program stored thereon, wherein the program instructs a computer to perform:
calculating an evaluation value for a content creator that creates content;
receiving plan information indicating a plan of the content planned by the content creator; and
presenting the evaluation value calculated at the calculating and the plan information received at the receiving and providing an auction service in which a bid target is a right to display an advertisement on the content.
